(19) United States
(12) Patent Application Publication
(10) Pub. No.: US 2026/0047553 A1
(43) Pub. Date: Feb. 19, 2026

(54) DEVICES, SYSTEMS, AND METHODS FOR A SMART CAT SCRATCHER

(71) Applicant: Busy Kitty, LLC, Chicago, IL (US)

(72) Inventor: Andrea Wandrey, Chicago, IL (US)

(73) Assignee: Busy Kitty, LLC, Chicago, IL (US)

(21) Appl. No.: 18/807,182

(22) Filed: Aug. 16, 2024

(51) Int. Cl. A01K 15/02

(52) U.S. Cl. CPC A01K 15/021; A01K 15/024

(57) ABSTRACT

A smart cat scratcher and a system for implementing a reward protocol for a smart cat scratcher, and/or methods of manufacturing and/or using the smart cat scratcher and system. The smart cat scratcher is configured to automatically dispense rewards in response to detected scratching activity by a cat. The smart cat scratcher includes a scratching surface, one or more sensors configured to detect the scratching activity, a scratcher controller, and a reward dispenser. The scratcher controller is programmed with a reward protocol that includes a training protocol and a maintenance protocol. The training protocol includes multiple training levels, each with corresponding reward schedules and criteria for graduation. The maintenance protocol includes a partial reinforcement schedule for maintaining established scratching behavior. The smart cat scratcher is configured to communicate with a user terminal to receive input and provide status updates regarding the cat's interaction with the smart cat scratcher.

### TECHNICAL FIELD

The present disclosure relates generally to pet devices, and more particularly to devices, systems, and methods for a smart cat scratcher.

### BACKGROUND

Cats are very popular pets in many households worldwide. By some estimates, over 45 million households in the U.S. alone have cats. Cats are known for their independent nature, playful behavior, and the companionship they offer to their owners. One of the natural behaviors of cats is scratching, which serves multiple purposes for the cat. Scratching helps cats to mark their territory, stretch their muscles, and maintain the health of their claws.

Unfortunately, without proper training, cats will scratch at anything they can get their claws into, such as furniture, curtains, carpets, and other household items. This can lead to extensive damage, as cats possess sharp claws that are capable of tearing through many materials with ease. The act of scratching not only satisfies their natural instincts but also helps them to keep their claws sharp and healthy. Consequently, untrained cats may inadvertently cause a considerable amount of destruction in their environment, much to the dismay of their human family. In addition, cats may be punished by yelling or even hitting when they scratch something they should not, and some owners declaw their cats to avoid damage, all of which can negatively impact cats' physical and emotional wellbeing. Finally, shelters are overpopulated with cats, and peoples' worry of destructive scratching keeps many cats from being adopted and living in the home they deserve.

Scratching posts and other scratching items are commonly used in households with cats to provide an appropriate outlet for this natural scratching behavior. Current scratching items come in various shapes, sizes, and materials, including vertical and horizontal scratchers, combination scratchers with additional features, wall-mounted scratchers, and protective scratchers designed to shield furniture from scratching behavior. The materials used for these scratchers can range from corrugated cardboard and sisal rope to various types of fabric, wood, and other materials.

However, training cats to use these scratching items instead of furniture, carpets, or other inappropriate objects is a common challenge for cat owners (if there is such a thing as owning a cat). The most effective and humane method for training cats is positive reinforcement, where desired behavior is reinforced with rewards. This method is endorsed by various animal welfare organizations and has been demonstrated to be effective in multiple studies. However, the process of training a cat to use a scratching post or other designated scratching item can be time-consuming and requires consistency from the owner, a feat that is far too often not accomplished.

For example, oftentimes the failure to train a cat may be due to a lack of time or interest in training, or a lack of knowledge on the effectiveness of reward-based training. In some cases, the challenges with positive reinforcement training for appropriate scratching behavior are related to the timing of the reward. For example, for the training to be effective, the reward for scratching at the correct location, such as a scratching post, must be given immediately, ideally within approximately three seconds of the behavior. This immediacy is necessary to ensure that the cat associates the reward with the action of scratching the designated object. However, this poses two main issues. Firstly, the cat owner may not be present at the exact moment when the cat engages in the appropriate scratching behavior, thus missing the opportunity to provide immediate positive reinforcement. Secondly, even if the cat owner is present, the cat owner may be too slow to deliver the reward due to the time it takes to observe the cat scratching, locate the treats, open the packaging, and then physically go over to the cat to offer the treat. In such cases, the training may fail to instill the desired behavior. Additionally, cats may quickly realize that the treat dispensing is dependent on the owner witnessing the scratching, leading to a situation where the cat scratches appropriately primarily when the owner is nearby, and it can anticipate receiving a treat. Over time, owners may also find the process of manually dispensing treats for cat scratches to be tiresome and burdensome, which can further hinder the consistency and effectiveness of the training. Consequently, the effectiveness of current cat scratchers may diminish without consistent and effective training, as cats may not develop a strong habit of using them and continue to scratch inappropriate household items.

In addition to scratching posts and other physical items, there are also various types of electronic cat toys available in the market. These toys often incorporate technology such as motion sensors, lights, sounds, and automated movements to stimulate a cat's natural instincts for hunting, pouncing, and chasing.

### BRIEF SUMMARY

The present disclosure achieves technical advantages as systems, devices, and methods for a smart cat scratcher. In particular embodiments, the smart cat scratcher may be configured with functionality for automatically dispensing rewards in response to scratching activity. In embodiments, the smart cat scratcher may provide functionality to encourage and/or train cats to engage in appropriate scratching behavior using the smart cat scratcher, rather than inappropriate scratching behavior on other items. In embodiments, the smart cat scratcher may include a scratching surface configured to withstand scratching activity by a cat. The smart cat scratcher may include one or more sensors configured to detect the scratching activity by the cat upon the scratching surface and to identify one or more characteristics associated with the scratching activity. In embodiments, a scratcher controller may be configured to determine, based on the detected one or more characteristics, whether to dispense one or more rewards. In response to a determination to dispense one or more rewards, the scratcher controller may send one or more signals to a reward dispenser of the smart cat scratcher. The reward dispenser may be configured to dispense the rewards in response to receiving the signals from the scratcher controller. The one or more rewards may include good-based rewards and/or interactive rewards.

In embodiments, the smart cat scratcher may implement and manage a reward protocol that is configured to automate and enhance the training process for appropriate scratching behavior. This reward protocol may be structured around a system of immediate positive reinforcement, which is a proven method for effectively training cats. Upon detecting a scratching activity by the cat, the one or more sensors provide data to the scratcher controller. The scratcher controller evaluates this data to determine the quality level of the scratching activity, such as intensity, duration, and pattern. Based on this evaluation, the scratcher controller determines whether the activity meets the criteria for a reward and sends a signal to the reward dispenser to release treats or other incentives.

The reward protocol of embodiments is configured with a dual approach, including a maintenance protocol and a training protocol. In embodiments, the maintenance protocol may be configured to sustain established scratching behavior by dispensing rewards intermittently, which may help to maintain the cat's interest in the scratcher without leading to over-reliance on treats. The training protocol, on the other hand, may include a progression of training levels with corresponding reward schedules that may be tailored to guide and enhance the cat's scratching behavior towards the scratching surface, rather than towards other items. As the cat interacts with the scratcher and demonstrates progress, the scratcher controller is configured to transition the cat through these training levels, each with distinct criteria for graduation.

In embodiments, the smart cat scratcher of embodiments may provide an automated solution to a common problem faced by cat owners, namely inappropriate scratching behavior. By dispensing rewards in response to appropriate scratching activity, the smart cat scratcher encourages cats to scratch on the designated surface rather than on furniture or other inappropriate objects. This represents a practical application of a technical innovation that can help protect household items from damage, reduce the frustration often experienced by cat owners, and contribute to cats' welfare.

Additionally, the smart cat scratcher of embodiments is configured to adapt to the individual cat's behavior. The scratcher controller of the smart cat scratcher may be configured with a reward protocol that includes multiple training levels, allowing the cat to progress from one level to another based on its scratching behavior. This adaptive approach to training can enhance the effectiveness of the training process and promote healthier scratching habits in cats.

Furthermore, the smart cat scratcher of embodiments offers the advantage of enabling monitoring of the cat's physical and mental health. By analyzing the data collected from the sensors regarding the frequency, intensity, and pattern of scratching, the scratcher controller may identify changes in the cat's behavior that may indicate health issues or stress. This proactive monitoring allows for early detection of potential problems, prompting timely veterinary consultations and interventions. Furthermore, the ability to track and evaluate the cat's interaction with the scratcher over time provides valuable insights into the cat's well-being, making the smart cat scratcher a device that supports both the physical and mental health of feline companions.

Indeed, the smart cat scratcher of embodiments represents a novel and practical solution to the problem of inappropriate cat scratching behavior. By integrating sensor technology, reward dispensing mechanisms, and adaptive training protocols, the smart cat scratcher provides an effective and user-friendly tool for training cats and promoting healthier scratching habits.

In various embodiments, the smart cat scratcher of embodiments may comprise one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a smart cat scratcher device that includes functionality for automatically dispensing rewards in response to scratching activity. It is a further object of the disclosure to provide a method of manufacturing a smart cat scratcher device configured for automatically dispensing rewards in response to scratching activity. It is still a further object of the disclosure to provide a system for implementing a reward protocol for a smart cat scratcher.

In one particular embodiment, a smart cat scratcher is provided. The smart cat scratcher includes a scratching surface, and one or more sensors configured to detect a scratching activity by a cat upon the scratching surface and to detect one or more characteristics associated with the scratching activity by the cat. The smart cat scratcher also includes a scratcher controller configured to determine, based on the one or more characteristics associated with the scratching activity by the cat, whether to dispense one or more rewards, and to send one or more signals to a reward dispenser in response to a determination to dispense one or more rewards. The smart cat scratcher further includes the reward dispenser configured to dispense the one or more rewards in response to receiving the one or more signals from the scratcher controller.

In another embodiment, a method of manufacturing a smart cat scratcher device is provided. The method includes disposing a scratching surface configured to withstand scratching activity by a cat and coupling one or more sensors to the scratching surface. In embodiments, the one or more sensors are configured to detect the scratching activity by the cat upon the scratching surface and to detect one or more characteristics associated with the scratching activity by the cat. The method also includes including a scratcher controller. In embodiments, the scratcher controller is configured to determine, based on the one or more characteristics associated with the scratching activity by the cat, whether to dispense one or more rewards and to send one or more signals in response to a determination to dispense one or more reward. The method further includes attaching a reward dispenser to the smart cat scratcher. In embodiments, the reward dispenser is configured to dispense the one or more rewards in response to receiving the one or more signals from the scratcher controller.

In another embodiment, a system for implementing a reward protocol for a smart cat scratcher is provided. The system comprises at least one processor and a memory operably coupled to the at least one processor and storing processor-readable code that, when executed by the at least one processor, is configured to perform operations. The operations include determining one or more characteristics associated with a scratching activity upon a scratching surface, and determining whether to dispense one or more rewards based on the one or more characteristics associated with the scratching activity in accordance with a reward protocol. In embodiments, the reward protocol includes a maintenance protocol for sustaining established scratching behavior and a training protocol for promoting and reinforcing desired scratching behavior, and the maintenance protocol includes intermittent dispensing of rewards to maintain the established scratching behavior. In embodiments, the training protocol includes a progression of training levels with corresponding reward schedules to guide the cat's scratching behavior towards the scratching surface, and the training protocol defines a transition of the cat through the training levels based on the cat's interaction with the scratching surface.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 shows an exemplary smart cat scratcher configured with capabilities and functionality for automatically dispensing rewards in response to scratching activity in accordance with embodiments of the present disclosure.

FIG. 2 is a block diagram illustrating a functional example of a scratcher controller configured with capabilities and functionality for managing the functionality of the smart cat scratcher for automatically dispensing rewards in response to scratching activity in accordance with embodiments of the present disclosure.

FIGS. 3A and 3B show an exemplary representation of a vertical configuration of the smart cat scratcher implemented with functionality in accordance with embodiments of the present disclosure.

FIGS. 3C and 3D show an example packaging configuration of the vertical configuration of the smart cat scratcher implemented with functionality in accordance with embodiments of the present disclosure.

FIG. 4 shows an exemplary representation of a horizontal configuration of the smart cat scratcher implemented with functionality in accordance with embodiments of the present disclosure.

FIGS. 5A-5F show various views of exemplary interface windows of a connected app illustrating the functionalities and settings available to the user for managing and accessing the functionality of the smart cat scratcher in accordance with embodiments of the present disclosure.

FIG. 6 shows an exemplary flow diagram of operations for manufacturing a smart cat scratcher configured with functionality for automatically dispensing rewards in response to scratching activity in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to a smart cat scratcher device and system, and/or methods of manufacturing and/or using a smart cat scratcher device, that includes functionality for automatically dispensing rewards in response to scratching activity. In embodiments, the smart cat scratcher may provide functionality to encourage and/or train cats to engage in appropriate scratching behavior using the smart cat scratcher, rather than inappropriate scratching behavior on other items. In embodiments, the smart cat scratcher may include a scratching surface configured to withstand scratching activity by a cat. The smart cat scratcher may include one or more sensors configured to detect the scratching activity by the cat upon the scratching surface and to identify one or more characteristics associated with the scratching activity. In embodiments, a scratcher controller may be configured to determine, based on the detected one or more characteristics, whether to dispense one or more rewards. In response to a determination to dispense one or more rewards, the scratcher controller may send one or more signals to a reward dispenser of the smart cat scratcher. The reward dispenser may be configured to dispense the rewards in response to receiving the one or more signals from the scratcher controller. The one or more rewards may include good-based rewards and/or interactive rewards.

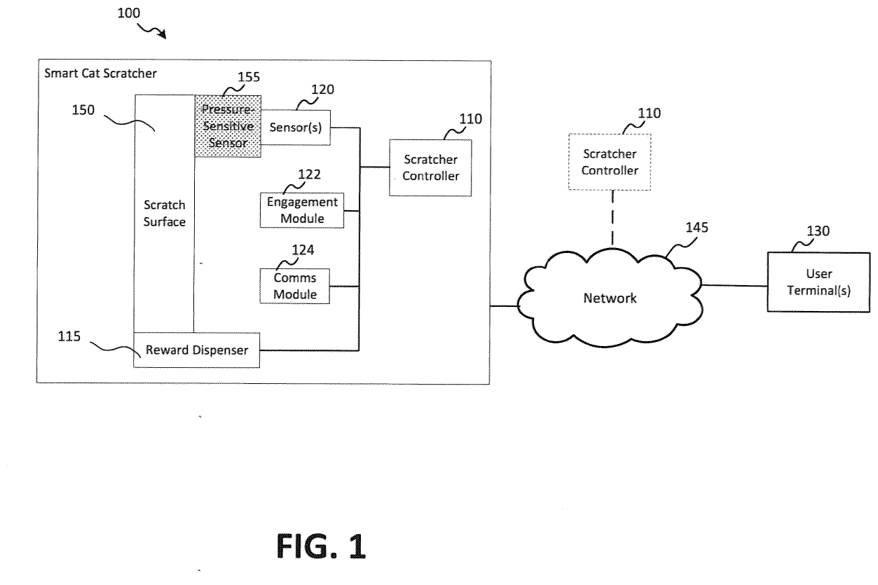

FIG. 1 shows an exemplary smart cat scratcher 100 configured with capabilities and functionality for automatically dispensing rewards in response to scratching activity in accordance with embodiments of the present disclosure. As shown in the particular embodiment illustrated in FIG. 1, smart cat scratcher 100 may include scratching surface 150, food-based reward dispenser 115, pressure sensitive sensor 155, one or more sensors 120, engagement module 122, communications module 124, and scratcher controller 110. In embodiments, these components of smart cat scratcher 100, and their individual components, may cooperatively operate to provide functionality for controlled dispensing of rewards in response to scratching activity as described in various embodiments of the present disclosure.

It is noted that in some embodiments, the smart cat scratcher 100 may be provided as a system including network 145, and user terminal 130. In these cases, the smart cat scratcher 100 may additionally include network 145 and user terminal 130. In some embodiments, the scratcher controller 110 may be part of the smart cat scratcher 100, such as may be an on-board component of the smart cat scratcher 100. In additional or alternative embodiments, the scratcher controller 110 may be provided as a separate component to the smart cat scratcher 100. In these cases, for example, the scratcher controller 110 may be provided as a server that is separate to the smart cat scratcher 100 and provides the functionality of the scratcher controller 110 as described herein.

It is also noted that various components of smart cat scratcher 100 are illustrated as single and separate components. However, it will be appreciated that each of the various illustrated components may be implemented as a single component, may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of smart cat scratcher 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

The user terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, the user terminal 130 may provide a user interface that may be configured to provide an interface (e.g., a graphical user interface (GUI)) structured to facilitate a user interacting with the smart cat scratcher 100, e.g., via network 145, to execute and leverage the features provided by the cooperative operations of smart cat scratcher 100. In embodiments, the GUI may be provided as part of an application that may enable the user to configure various parameters for the smart cat scratcher 100. Through the GUI of the application, the user may personalize settings related to the operation of the smart cat scratcher, create and manage profiles for different cats, set preferences that align with their training goals and household routines, etc. The application may also facilitate the configuration of training programs, allowing for the adjustment of reward schedules, reward types, dispensing frequencies, etc. In embodiments, the user may receive reports, notifications, alerts, etc. via the GUI of the application in accordance with embodiments of the present disclosure. In embodiments, the user terminal 130 may be configured to communicate with other components of smart cat scratcher 100.

In embodiments, network 145 may facilitate communications between the various components of the system including the smart cat scratcher 100. Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

In embodiments, the scratching surface 150 may be configured to engage cats in their natural scratching behavior. In some embodiments, the scratching surface 150 is configured to withstand the scratching of cat claws and may provide a durable and satisfying experience for the cat as they engage with the scratching surface 150. The scratching surface 150 may be configured to be scratched by cats, while offering resistance that mimics natural materials cats might encounter in the wild, such as tree bark or rough terrain.

In embodiments, the scratching surface 150 may be configured to be interchangeable. This functionality may enable users to easily remove and replace the scratching surface 150 as it wears down or as preferences change. This feature may not only enhance the longevity of the smart cat scratcher but may also provide flexibility for the user. In some embodiments, replacing the scratching surface 150 may include sliding the worn surface out of the scratching surface holder and sliding in a new one. In some embodiments, a replaceable scratching surface 150 may facilitate a subscription-based model for vendors, offering users the convenience of receiving periodic replacements. This “subscribe and save” option ensures that cats consistently have a fresh and effective surface for scratching, while providing a recurring revenue stream and enhanced customer engagement for vendors.

In some embodiments, the scratching surface 150 may be composed of multiple sections, which may be individually replaced or rearranged. This modular configuration may allow for a customizable scratching experience and can cater to the varied scratching preferences of different cats. For instance, some cats may prefer a larger, uninterrupted surface to stretch and scratch, while others may enjoy a segmented arrangement that offers different textures or angles. The modular configuration's compact size may also offer advantages in shipping and storing.

In embodiments, the material used to make the scratching surface 150 may vary to suit the preferences of both cats and their owners. Common materials that may be used for the scratching surface 150 may include sisal rope, known for its durability and texture that cats find appealing; corrugated cardboard, which provides a softer scratching experience and is often preferred by indoor cats; carpet, which can offer a familiar texture found in many homes, etc. For example, other materials that may be used for the scratching surface 150 may include wood, fabric, felt, leather, hemp rope, bamboo, wicker, natural bark or tree branches, any combination thereof, and/or other materials. Different materials may provide distinct scratching experiences and may be selected based on the cat's individual behavior and the owner's aesthetic preferences.

In embodiments, the smart cat scratcher 100 may be configured with reward dispensing functionality. For example, the smart cat scratcher 100 may include a reward dispenser that includes functionality of the food-based reward dispenser 115 and the engagement module 122.

The food-based reward dispenser 115 may be configured to hold and release rewards to provide immediate positive reinforcement to the cat. These rewards may include, but are not limited to, traditional treats, regular cat food (e.g., kibble), catnip, silver vine, other food-based treats, and/or any combination thereof. While treats may be more attractive to most cats than kibble, the inclusion of kibble may enable the smart cat scratcher 100 to incorporate a cat's regular meals into the training scheme, whether in part or in total. This functionality may add an interactive and enriching element to the meals, like how feral cats may hunt and earn their meals in the wild. In addition, this may result in the training not being restricted by the calories a cat may consume in treats but may take advantage of some or all of the calories the cat consumes in their meals. The inclusion of catnip and silver vine as potential rewards provides an alternative to food-based treats, which can be particularly useful for cats that are less food-motivated or for owners who are mindful of their cat's caloric intake. The food-based reward dispenser 115 may be programmed to release these rewards either individually or in combination, depending on the cat's response and the owner's training objectives.

In some embodiments, the rewards may include a variety of rewards to cater to the diverse preferences of cats. This feature may be especially useful in the context of reward-based training. The selection of a “high value” treat is paramount, as it can greatly influence the effectiveness of the training. A high value treat is one that the cat finds particularly appealing and is more likely to motivate the desired behavior. Since different cats have varying preferences, the food-based reward dispenser 115 may be configured to handle a diverse range of treats, accommodating different sizes, shapes, and textures, from soft to hard. This flexibility allows the owner to use the cat's favorite treat, enhancing the positive reinforcement strategy. To cater to multi-cat households, the food-based reward dispenser 115 may be configured with two treat-dispenser slots, enabling the dispensing of different types of treats—such as salmon or chicken—to suit the individual preferences of each cat. This feature ensures that each cat is motivated by its preferred high value treat, which is especially useful when the cats have distinct treat preferences. Similarly, different cats often consume different types of regular meals (e.g., kibble), due to flavor preference or specific dietary needs, so that the food-based reward dispenser 115 may be configured to handle a diverse range of cat's regular food (e.g., different kinds of kibble), and the cat's regular food may be dispensed via either one or two dispenser slots, separate from or in combination with the treats.

The food-based reward dispenser 115 may include a reward slot through which the cat can directly receive the dispensed reward, providing an immediate and tangible reward for the scratching activity. This reward slot may be positioned in a location that is easily accessible to the cat, ensuring that the treat can be retrieved without difficulty. In some embodiments, the food-based reward dispenser 115 may be equipped with a reward sprinkler mechanism. This mechanism may be configured to sprinkle a reward, such as catnip or silver vine, over the scratching surface 150 or in the vicinity of the smart cat scratcher 100. The sprinkling action serves as an additional sensory stimulus for the cat, further reinforcing the positive association with the scratching activity and encouraging continued use of the scratcher. The reward sprinkler may be particularly engaging for cats, as it disperses the reward in a playful manner that simulates natural foraging behavior.

In embodiments, the rewards in the rewards dispenser 115 may be refillable, allowing owners to replenish the reward supply as it depletes, ensuring that the training process is not interrupted due to a lack of rewards. The food-based reward dispenser 115 may include a storage container configured to hold a certain amount of reward. The food-based reward dispenser 115 may be equipped with an actuator attached to a door or gate, which, when actuated, may allow a set amount or number of rewards to be released from the storage container, releasing the rewards. The actuating of the actuator may be in response to an automatic control signal received from the scratcher controller 110, which may be generated by the scratcher controller 110. In some embodiments, the actuator of the food-based reward dispenser 115 may be configured to operate quickly, ensuring that the reward is dispensed within the ideal timeframe (e.g., less than three seconds in some embodiments, although in some embodiments may be less than a longer period of time, such as less than 10 seconds) following the detected scratching activity, as per the principles of positive reinforcement training.

In embodiments, the food-based reward dispenser 115 may include a refill slot accessible for reloading the rewards. This refill slot may be configured to accommodate a variety of reward sizes and shapes, providing flexibility for owners to use their cat's preferred rewards. The food-based reward dispenser 115's storage container may be sufficiently large to hold a substantial amount of reward, reducing the frequency of refills and allowing for longer, uninterrupted training sessions. Additionally, or alternatively, the food-based reward dispenser 115 may include a mechanism to control the quantity of treats dispensed, supporting the owner's ability to manage their cat's dietary intake and prevent overfeeding.

In embodiments, upon detecting a valid scratching event, the scratcher controller 110 may send a control signal to the food-based reward dispenser 115, which may activate the actuator. The actuator's movement causes the release of a predetermined amount of reward, which may then be made available to the cat. As described in more detail herein, the amount of reward that is released can be tuned through the connected application, allowing owners to set parameters such as the size of the reward based on the quality of the scratch or the cat's training progress, profile, or level.

In embodiments, the one or more sensors 120 may be configured to detect scratching activity on the scratching surface 150 of the cat scratcher device 100, and/or to detect one or more characteristics associated with the scratching activity on the scratching surface 150. In embodiments, detecting scratching activity on the scratching surface 150 may include detecting the presence and activity of a cat as it engages with the scratching surface 150.

In embodiments, detecting the one or more characteristics associated with the scratching activity may include detecting one or more characteristics related to the quality of the scratching activity. Characteristics related to the quality of the scratching activity may include the intensity of the scratching activity, which may vary from light touches to more vigorous scratching. The characteristics related to the quality of the scratching activity may include the pressure applied by the cat's claws upon the scratching surface 150, which may provide insights into the cat's behavior and preferences. The characteristics related to the quality of the scratching activity may include a length of each scratching activity, which may be indicative of the cat's engagement level and satisfaction with the scratching experience. The characteristics related to the quality of the scratching activity may include the depth and sharpness of the scratches, which may be indicative of the cat's claw health or the cat's intent, whether it is marking territory, stretching, or simply enjoying the act of scratching. The characteristics related to the quality of the scratching activity may include the rhythm and pattern of the scratching, which can vary from cat to cat and may change over time as the cat's behavior evolves. The characteristics related to the quality of the scratching activity may include the cat's body posture while scratching, which may be indicative of the cat's mood, intent of scratching to stretch, and eagerness to please the owner in return for treats. In some embodiments, the characteristics related to the quality of the scratching activity may include the speed at which the cat approaches the scratching surface, where a cat running towards and lounging at the scratching surface may be indicative of a playful mood, while in other instances the cat may casually walk up to the surface and scratch in a more relaxed manner.

In embodiments, the characteristics related to the quality of the scratching activity may include the direction of the scratching activity, whether it is vertical, horizontal, or diagonal, as well as the size of the area being scratched. This level of detail may allow the smart cat scratcher 100 to differentiate between a casual pass-by and an intentional scratching session. By capturing these various characteristics, the one or more sensors 120 may provide useful data that may inform the scratcher controller 110 of the smart cat scratcher 100 for deciding whether to dispense a reward, according to the configuration of the smart cat scratcher 100.

In embodiments, the one or more characteristics associated with the scratching activity may include characteristics related to the cat performing the scratching activity. The characteristics related to the cat performing the scratching activity may include an identity of the individual cat, especially in a multi-cat household, the training level of the cat, the number of rewards and/or the calories already received within a time period by the cat to prevent overfeeding, as well as the number of scratches performed within a time period to assess the cat's engagement with the scratcher.

In embodiments, the one or more characteristics associated with the scratching activity may include characteristics related to the environment of the scratching activity. The characteristics related to the environment of the scratching activity may include the time of day, which can help establish the cat's scratching patterns and preferences, environmental factors such as temperature, humidity, or light levels, which can influence a cat's scratching behavior.

In embodiments, the one or more sensors 120 may include pressure-sensitive sensor 155, which may include one or more pressure-sensitive sensors positioned proximate to and/or behind the scratching surface 150. The pressure-sensitive sensor 155 may be configured to detect the presence and activity of a cat as it engages with the scratching surface 150. When a cat begins to scratch the scratching surface 150, the pressure-sensitive sensor 155 may be activated by the pressure and movement exerted on the surface, capturing the characteristics of the cat's interaction with the scratching surface 150. In this manner, the pressure-sensitive sensor 155 may operate to detect and/or measure scratching activity upon the scratching surface 150.

In embodiments, the pressure-sensitive sensor 155 may be configured to detect at least a portion of the one or more characteristics related to the quality of the scratching activity. For example, the pressure-sensitive sensor 155 may be configured to detect the intensity of the scratching activity, the pressure (e.g., as measured by the pressure-sensitive sensor 155) applied by the cat's claws upon the scratching surface 150, a length of the scratching activity, a direction of the scratching activity, whether it is vertical, horizontal, or diagonal, the size of the area being scratched, as well as the location on the scratching surface 150 upon which the scratching activity occurs (e.g., towards the top or towards the bottom). This level of detail may allow the smart cat scratcher 100 to differentiate between a casual pass-by and an intentional scratching session. By capturing these various characteristics, the pressure-sensitive sensor 155 may provide useful data that may inform the scratcher controller 110 of the smart cat scratcher 100 for deciding whether to dispense a reward, according to the configuration of the smart cat scratcher 100.

It is noted that in some embodiments, the smart cat scratcher 100 may not include a pressure-sensitive sensor 155. Instead, the detection and measurement of scratching activity, including the one or more characteristics such as intensity, duration, and/or frequency of the scratches, may be accomplished using alternative types of sensors.

In embodiments, the one or more sensors 120 may include motion sensors configured to detect the movement associated with scratching behavior, including the velocity, intensity, duration, and/or pattern of movement that occurs when a cat scratches the surface. Motion sensors may be particularly useful in distinguishing between different types of scratching motions, such as vertical or horizontal scratches.

In embodiments, the one or more sensors 120 may include proximity sensors configured to detect when a cat is near or in contact with the scratching surface 150. In this manner, the proximity sensors may be configured to detect the scratching activity. In embodiments, the one or more sensors 120 may include infrared sensors configured to detect the heat signatures of the cat's paws, providing an additional layer of detection that can be particularly effective in low-light conditions. Infrared sensors may help ensure that the cat scratcher device 100 is responsive to the cat's presence and activity at all times.

In embodiments, the one or more sensors 120 may include acoustic sensors configured to listen for the sound of scratching, which may be analyzed to determine the quality and frequency of the scratches. For example, acoustic sensors may operate to differentiate between the sounds of different scratching intensities and patterns. In some embodiments, the acoustic sensors may include a microphone, which may serve several purposes. For example, the microphone can enhance the detection capabilities of the cat scratcher device 100 by listening for the specific sounds of a cat's claws making contact with the scratching surface 150, contributing to the precise triggering of the reward mechanism. The microphone can also listen for the quality and frequency of the scratching activity, especially in cooperative operation with the scratcher controller 110. Moreover, the microphone may facilitate two-way communication sessions between the cat and the owner. This allows the owner to listen to their cat and respond accordingly (e.g., over a speaker of the smart cat scratcher 100), whether it's to offer words of encouragement during a training session or to provide comfort with a familiar voice when the owner is not physically present.

In embodiments, the one or more sensors 120 may include one or more cameras. The one or more cameras may be configured to capture image and/or video data associated with the cat and/or the scratch activity. In some embodiments, the image and/or video data may be used to detect the cat's presence and the scratch activity, providing a visual confirmation of the interaction and information on the quality of the scratching activity. In some embodiments, this data may include information on the cat's body posture as indication of the quality of the scratching activity. In some embodiments, the image and/or video data may be used for applying object recognition algorithms to distinguish between a cat and other creatures (e.g., a dog), ensuring that the reward system is triggered appropriately. Additionally, facial recognition technology may be employed to identify individual cats, especially in households with multiple feline occupants, allowing for personalized training and reward protocols.

The one or more cameras may also facilitate the use of artificial intelligence (AI) to determine the one or more characteristics related to the quality of the scratching activity. By analyzing the video data, the AI can assess the intensity, depth, pressure, length, duration, vigor, pattern, direction, etc., of the scratches, which may be indicative of the cat's engagement with the scratching experience. In some embodiments, the image and/or video data may be used to record the scratching session for later reference by the owner, who may wish to monitor their cat's progress or share endearing moments with friends and family.

In some embodiments, the one or more cameras may facilitate communications between the cat scratcher and a user. For example, an owner could “talk” to their cat through a connected application, providing comfort and interaction even when they are not physically present. This feature may operate to enhance the bond between the cat and its owner, making the smart cat scratcher 100 a central part of their shared environment.

In embodiments, the data collected or captured by the one or more sensors 120 may be analyzed and processed by the scratcher controller 110, which may determine the appropriate response based on the one or more characteristics of the detected scratching activity and/or various configuration parameters. If the activity meets predetermined criteria, such as a specific intensity or duration, and if allowed by the configuration parameters, the scratcher controller 110 may send a signal to the food-based reward dispenser 115 to trigger the food-based reward dispenser 115 to release a reward (e.g., to actuate a gate or door of the food-based reward dispenser 115 to allow a food-based reward to be released to the cat, and/or to actuate engagement module 122 to provide an interactive reward, and/or to actuate communications module 124 to initiate a communications session between the smart scratcher 100 and a user allowing the cat to “talk” to the user, which can be the cat's human parent). This immediate positive reinforcement encourages the cat to continue using the scratching surface 150, reinforcing the desired behavior.

The engagement module 122 may be configured to interact with the cat. The interaction with the cat by the engagement module 122 may serve multiple purposes. For example, in some embodiments, the engagement module 122 may be configured to interact with the cat in a variety of ways to encourage the cat to use the cat scratcher device 100 and to deter it from scratching other household items. Additionally, or alternatively, the engagement module 122 may be configured to interact with the cat to provide interactive rewards in response to scratching activity. In embodiments, the engagement encouragement and the interactive rewards may include the same activities, but the engagement encouragement activities may be activated, actuated, made accessible, and/or triggered in response to a determination (e.g., by the scratcher controller 110) to encourage interaction with the smart cat scratcher (e.g., based on a determination that the cat has not interacted with the smart cat scratcher 100 in a period of time longer than a threshold), whereas the interactive rewards may be activated, actuated, made accessible, and/or triggered in response to a determination (e.g., by the scratcher controller 110) to dispense a reward to the cat in response to a scratching activity.

It is noted at this point, that the rewards dispensed by the smart cat scratcher 100 may include food-based rewards (e.g., regular food, such as kibble, treats, catnip, silver vine, etc.) as described above, may include interactive rewards, such as interactive play, grooming, petting, etc., as provided by the engagement module 122, and/or may include a communications session between the smart scratcher 100 and a user to allow the cat to “talk” to the user. In any case, the rewards dispensed by the smart cat scratcher 100 may be in response to a detected scratching activity in accordance with embodiments described herein.

In embodiments, the activities provided by the engagement module 122 may include interactive play, petting, and grooming simulations. For example, the engagement module 122 may be equipped with a variety of toys, such as moving flirt-pole or dangling toys that mimic the movement of prey, enticing the cat to engage in natural hunting and pouncing behaviors, which may be activated in response to an activation or automatic control signal from the scratcher controller 110. Additionally, or alternatively, the engagement module 122 may include tactile stimuli that simulate the sensation of being groomed or petted, which can be comforting and rewarding for the cat, and which may be activated in response to an activation signal from the scratcher controller 110.

In embodiments, the engagement module 122 may also incorporate visual, auditory, video, or tactile stimuli to captivate the cat's attention and stimulate its instincts. Visual stimuli may include lights or laser shows that create patterns for the cat to chase, while auditory stimuli might involve a variety of sounds, from soothing melodies to exciting chirps that mimic birds or other prey, and/or may include a sound to reinforce the cat's behavior (e.g., a “good” command, a soothing and/or familiar voice, and/or a clicker-sound such as used in “clicker training.”) Auditory stimuli may further include a pre-recorded word, phrase, sound, or message from the owner. Tactile stimuli could be provided by moving parts on the scratcher that the cat can bat at or rub against. Video stimuli may include pre-recorded videos (e.g., such as videos of calming imagery, of the owner, etc.). For example, in some embodiments, the smart cat scratcher 100 may include a monitor or screen that may be configured to play videos to provide the video stimuli.

In embodiments, the engagement module 122 may include a scent module that releases scents appealing to cats, such as catnip or silver vine scents, to attract the cat to the scratcher. A sound module, such as a speaker, may be used to play calming or stimulating sounds, and it may also enable the cat's owner to communicate with their pet remotely or to play a pre-recorded voice and/or video recording from the owner, providing reassurance or commands. In some embodiments, the engagement module 122 may include a pheromone module (e.g., a pheromone diffuser), configured with one or more types of pheromones configured to attract cats. This pheromone module may be especially useful in early phases of training.

The communications module 124 may be configured to facilitate data exchange between the cat scratcher device 100 and one or more user terminal(s) 130, such as a smartphone, tablet, or computer, via a network 145. The communications module 124 may include various components or features for transmitting and receiving data, such as a wireless transceiver, a wired connection interface, or other suitable communication components. The communications module 124 may enable remote monitoring and control of the cat scratcher device 100, allowing a user to adjust settings, view data, or receive notifications related to the cat's interaction with the cat scratcher device 100.

In embodiments, the communications module 124 may facilitate two-way communication between the user and the smart cat scratcher device 100. This feature allows the user to interact with their cat in real-time, providing a sense of presence and engagement even when they are not physically together. Through the user terminal 130, an owner may initiate a call to the smart cat scratcher 100, activating the microphone and speaker system to communicate directly with their cat. This may be particularly comforting for the cat when the owner is away from home, as it can hear the owner's voice and receive reassurance. Conversely, the owner may listen in to the sounds around the smart cat scratcher, including the cat's vocalizations, which may be a valuable tool for monitoring the cat's well-being and environment.

In embodiments, the communications module 124 may be configured to enable communications via network 145, such as with other components of a system including the smart cat scratcher device 100, as well as external components. In a particular embodiment, the communications module 124 may be configured to enable communications protocol such as Bluetooth, WIFI, and other communications protocols that enable the smart cat scratcher device 100 to communicate.

In embodiments, the communications module 124 may include a privacy mode to enhance security and protect user privacy. When activated, this privacy mode may encrypt all communications between the smart cat scratcher device 100 and other devices (e.g., the user terminal 130) to protect sensitive data such as video feeds, audio transmissions, and user settings from potential interception by unauthorized parties. In some embodiments, the privacy mode may allow users to temporarily disable the camera and microphone functionalities of the smart cat scratcher device 100, preventing external actors from gaining unauthorized access to these devices and/or sensors.

The scratcher controller 110 may be configured to manage the functionality of the smart cat scratcher 100 for controlled dispensing of rewards in response to scratching activity in accordance with embodiments of the present disclosure. In particular, the scratcher controller 110 may be configured to manage the reward protocol of the smart cat scratcher 100 to determine when and how rewards are dispensed to a cat in response to scratching activity, and/or when to engage interactive activities to encourage the cat to interact with the smart cat scratcher 100. The scratcher controller 110 operates as the central processor of the smart cat scratcher 100, interpreting data from the one or more sensors 120 to determine the appropriate reward response, and activating the food-based reward dispenser 115, the engagement module 122, and/or the communications module 124 appropriately. In embodiments, the controller 110 may use configuration data, such as maximum treat amounts, designated quiet hours, the selected training mode, etc. to make real-time decisions about dispensing rewards.

In embodiments, the scratcher controller 110 may operate in various modes. The two main modes of operation of the scratcher controller 110 may include the maintenance mode and the training mode. In maintenance mode, the scratcher controller 110 operates to preserve the scratching habits of a trained cat. The scratcher controller may use a less frequent reward schedule to ensure the cat continues to interact with the scratcher rather than other household items. This intermittent or partial reinforcement strategy may help to solidify or reinforce the cat's learned behavior, making the scratcher the preferred outlet for scratching. The controller 110 may adjust the frequency of rewards based on the cat's interaction level, ensuring that the cat remains engaged with the scratcher without becoming reliant on constant treats.

In training mode, the scratcher controller 110 may be configured to facilitate a cat's progression from engaging in undesirable scratching to utilizing the smart cat scratcher 100. To accommodate varying stages of learning, the controller 110 operates across multiple training levels, such as beginner, advanced, and expert, each with corresponding reward criteria, reward schedules, reward intensities, and/or reward types. For example, for beginners, the controller 110 may utilize a continuous reinforcement schedule and may dispense a reward for every scratching activity, even those of low or weak quality, to establish the initial association between scratching the designated surface and receiving a treat. As the cat advances, the reward criteria may be narrowed to only reward scratching activity that exceed a certain quality threshold and the reward frequency may be reduced. In the expert level, the controller 110 may employ a partial reinforcement schedule, providing rewards less predictably to effectively maintain the learned behavior and prevent over-reliance on treats. In the same manner, the progression of a cat through various training levels may be managed by controlling the reward type and reward intensity along with or in the alternative to the reward criteria and schedule as described above. This tiered approach to positive reinforcement may be tailored to the individual cat, for example based on the cat's level of experience with scratchers, learning curve, observed behavior, physical state, and personality, ensuring an effective and efficient training experience.

In embodiments, cats may be graduated from one training level to another based on determinations that the cat is ready for a higher training level. These determinations may include various indications of the cat's progress and proficiency in using the smart cat scratcher 100. For example, the scratcher controller 110 may consider factors such as the cat having been at a particular level for a threshold duration of time, consistently performing scratches at or above a certain quality level, and/or maintaining a specific frequency of interaction with the smart cat scratcher 100. The scratcher controller 110 may also take into account the cat's overall engagement with the device, including the regularity of use and the cat's response to different types of rewards. In some cases, the graduation criteria may include a combination of these factors, ensuring that the cat has truly mastered the current level before progressing to the next.

The scratcher controller 110 may be configured to dispense different types of rewards based on the cat's preferences and the owner's settings. While food-based rewards (e.g., regular food such as kibble, treats, catnip, and/or silver vine) are the primary form of reward, the controller 110 may, in some embodiments, be configured to dispense alternative rewards such as interactive rewards. The type and quantity of the reward are determined by the controller 110, which takes into account the cat's behavior, scratching activity, dietary requirements, the cat's physical state, the owner's preferences, and the specific training objectives.

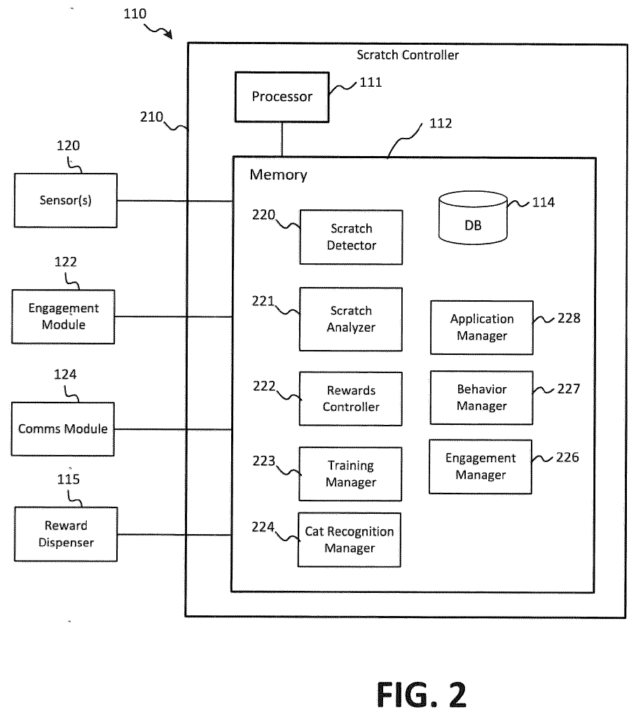

Functionality and operations of the scratcher controller 110 will now be discussed with respect to FIG. 2. FIG. 2 is a block diagram illustrating a functional example of a scratcher controller 110 configured with capabilities and functionality for managing the functionality of the smart cat scratcher 100 for automatically dispensing rewards in response to scratching activity in accordance with embodiments of the present disclosure. As shown in FIG. 2, the scratcher controller 110 may be implemented in a computing device 210. In embodiments, functionality of the computing device 210 to facilitate operations of the scratcher controller 110 may be provided by the cooperative operation of the various components of the computing device 210, as will be described in more detail below.

It is noted that although FIG. 2 shows the computing device 210 as a single computing device (e.g., a server, a user terminal, etc.), it will be appreciated that the computing device 210 (and the individual functional blocks of the computing device 210) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of the computing device 210 as single and separate blocks, each of the various components of the computing device 210 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of the computing device 210 may actually be part of a different component of the computing device 210, and as such, the description of the particular functionality described for the particular component of the computing device 210 is for illustrative purposes and not limiting in any way.

As shown in FIG. 2, the scratcher controller 110 includes processor 111, memory 112, scratch detector 220, scratch analyzer 221, rewards controller 222, training manager 223, cat recognition manager 224, engagement manager 226, behavior manager 227, application manager 228, and database 114.

Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise a database 114 for storing various information related to operations of the smart cat scratcher 100. For example, database 114 may store configuration information related to operations of the scratcher controller 110. In embodiments, database 114 may store information related to various models used during operations of scratcher controller 110, such as AI and/or machine learning algorithms used to analyze the captured scratching activity data to determine the quality of scratch, and/or the condition of a cat, and/or used to manage the reward protocol as a cat progresses (or regresses). In embodiments, database 114 may store data related to the personalization of the smart cat scratcher device 100. This data may include storing user-specific settings, such as preferences for reward dispensing criteria, schedules, reward types, quiet hours during which no rewards are dispensed, the physical location of each scratcher within the user's environment, etc. Additionally, database 114 may maintain comprehensive profiles for each cat, including cat identity, age, training level, and dietary considerations like daily treat limits, kibble limits, and calorie limits. Database 114 may also store scratching-related metrics, such as the number and frequency of scratches, which can be used to monitor the cat's engagement with the scratcher and adjust training protocols accordingly. Furthermore, database 114 may store thresholds that trigger notifications to the user, such as when scratching activity deviates from established patterns, potentially indicating a change in the cat's health or behavior. Video and/or image data captured by the smart cat scratcher 100's camera may also be stored, providing visual records of the cat's interactions with the smart cat scratcher 100 for further analysis or sharing with the user through the connected application. Database 114 may further store data that enables cat recognition, such as biometric data and microchip data.

Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

The scratch detector 220 may be configured to detect an interaction between the cat and the scratching surface 150, based on data from the one or more sensors 120, including the pressure-sensitive sensor 155. For example, the scratch detector 220 may be configured to detect a scratching activity and/or other kinds of activity and/or forms of contact upon the scratching surface 150, based on data from the one or more sensors 120. In some embodiments, the scratch detector 220 may be configured to detect different states or levels of interaction by the cat upon the scratching surface 150 and/or to distinguish between the different levels of interaction. For example, the scratch detector 220 may be configured to detect the absence of contact upon the scratching surface 150, to detect the presence of a paw upon the scratching surface 150 without scratching the scratching surface 150, and/or to detect the active scratching of a paw upon the scratching surface 150. The functionality of the scratch detector 220 to detect and/or to differentiate between the different levels of interaction with the scratching surface 150 may operate to ensure that rewards are dispensed appropriately and that the smart cat scratcher 100's responses are tailored to the cat's actual behavior.

In some embodiments, the scratch detector 220 may be configured to detect or determine the intensity of the scratches upon the scratching surface 150. For example, the scratch detector 220 may analyze the data from the one or more sensors 120 to determine the force, duration, pattern, direction, etc. of each scratch. By recognizing the nuances of the cat's interaction with the scratching surface 150, the scratch detector 220 may accurately identify when a scratch has occurred, as opposed to other forms of contact. This functionality may enable the smart cat scratcher 100 to prevent false triggers of the reward mechanism, ensuring that the cat is rewarded for the desired behavior of scratching, rather than for simply resting on or touching the surface.

In one embodiment, the scratch detector 220 may be configured to differentiate or distinguish between a cat sitting on the scratching surface 150 and a cat actively scratching the scratching surface 150. This functionality may be especially useful in horizontal configurations of the cat scratcher 100, where cats may be prone to lounge on the surface. The scratch detector 220 may leverage or use advanced algorithms and/or AI models to interpret the sensor data from the one or more sensors 120, enabling the scratch detector 220 to recognize the static pressure of a sitting cat versus the dynamic pressure and motion of scratching. This functionality may ensure that the food-based reward dispenser 115 is activated by scratching activity alone, reinforcing the correct behavior and preventing the dispensing of treats for inactivity or unintended use of the scratching surface. In some embodiments, the characteristics related to the quality of the scratching activity may include the cat's body posture as it performs the scratching, such as the cat reaching up or arching its back to get a good stretch. In some embodiments, the characteristics related to the quality of the scratching activity may further include the speed at which the cat approaches the scratching surface, where running and lounging towards the scratching surface may demonstrate a playful mood with highly engaged scratching.

In embodiments, upon detecting scratching activity, the scratch detector 220 may generate a signal configured to initiate a reward protocol. The reward protocol may include rules and settings that may be used to determine whether a reward is to be dispensed to the cat in response to the scratching activity. In embodiments, the signal generated by the scratch detector 220 may operate as a trigger for the scratcher controller 110 to evaluate the scratching activity based on the analysis performed by the scratch analyzer 221 and other settings, such as the current training mode or user-defined preferences. The decision to dispense a reward takes into account various factors, including the intensity, duration, and frequency of the scratches, as well as the cat's training progress and dietary restrictions.

The scratch analyzer 221 may be configured to analyze the scratching activity detected by the scratch detector 220. In embodiments, the scratch analyzer 221 may perform analysis of the data collected by the one or more sensors 120, associated with the detected scratching activity, including the pressure-sensitive sensor 155. The scratch analyzer 221 may process the data from the one or more sensors 120 to detect one or more characteristics associated with the scratching activity, which may provide an insight and/or understanding of the scratching activity.

In embodiments, the one or more characteristics associated with the scratching activity may include characteristics related to the quality of the scratching activity upon the scratching surface 150 and may include the depth and sharpness of the scratches, which may be indicative of the cat's claw health or the cat's intent, whether it is marking territory, stretching, or simply enjoying the act of scratching. In some embodiments, the characteristics related to the quality of the scratching activity may include the rhythm and pattern of the scratching, which may vary from cat to cat and may change over time as the cat's behavior evolves.

In embodiments, the one or more characteristics associated with the scratching activity may include characteristics related to the cat performing the scratching activity, such as the identity of the individual cat, which may include leveraging the functionality of the cat recognition manager 224 as described herein. In some embodiments, the characteristics related to the cat performing the scratching activity may include the training level of the cat, which may include improvements or regressions in scratching behavior. Additionally, or alternatively, the characteristics related to the cat performing the scratching activity may include the number of rewards already received within a time period to prevent overfeeding, as well as the number of scratches performed within a time period, which may indicate the cat's engagement with the scratcher.

In embodiments, the one or more characteristics associated with the scratching activity may include characteristics related to the environment of the scratching activity, and may include the time of day, which can help establish the cat's scratching patterns and preferences. For example, some cats may be more active at dawn or dusk, and the smart cat scratcher can adapt its reward system to these active periods to maximize training efficacy. Other characteristics related to the environment of the scratching activity may include temperature, humidity, or light levels, which may influence a cat's scratching behavior. In embodiments, correlating these environmental characteristics with scratching activity, may provide insights into the cat's preferences and well-being.

The rewards controller 222 may be configured to determine the dispensing of a reward in response to detected scratching activity. In embodiments, the functionality of the rewards controller 222 to determine the dispensing of a reward in response to detected scratching activity may include functionality for implementing a reward protocol that includes rulesets to ascertain the appropriate timing for dispensing rewards. In embodiments, the reward protocol may be configured to implement several modes or protocols. For example, in one particular embodiment, the reward protocol may be configured to implement two main protocols: a maintenance protocol and a training protocol.

In embodiments, the maintenance protocol may be configured to sustain or maintain a cat's (e.g., a trained cat and/or a cat that has reached a threshold level of training, such as an expert level or beyond) established scratching habits on the smart cat scratcher 100, while the training protocol may be configured to guide the cat towards developing these desirable scratching behaviors. Each protocol may be governed, managed, or otherwise implemented by specific rules that dictate the timing, frequency, and conditions under which rewards are dispensed, ensuring that the cat receives positive reinforcement that is both timely and appropriate to its current training level and behavior. These modes will be described in more detail in the following paragraphs, outlining how they contribute to the overall training strategy and the cat's well-being.

Generally, such as applicable to one or more of the maintenance and training protocol, the decision of the rewards controller 222 based on the reward protocol to dispense a reward may be based on the results of the scratch analyzer 221, such as the one or more characteristics associated with the scratching activity. For example, the scratch analyzer 221 evaluates the one or more characteristics associated with the scratching activity, such as the depth, sharpness, rhythm, and pattern of the scratches, etc., which may be sent to and received by the rewards controller 222. In a particular example, the rewards controller 222 may determine to dispense a reward if the quality of the scratch exceeds a predetermined quality threshold. This quality threshold may be based on various factors including, but not limited to, the duration, intensity, and pattern of the scratches, or any combination thereof. By utilizing such criteria, the rewards controller 222 may ensure that rewards are dispensed not just reactively, but also reflective of the quality of the scratching activity, which may operate to reinforce the desired behavior more effectively.

In some embodiments, the rewards controller 222 may utilize adjustable reward dispensing settings to further customize the reward protocol. These settings may include settings such as a maximum treat limit, regular food (e.g., kibble) limit, and/or calorie limit per day per cat, ensuring that each individual cat does not exceed a specific number of rewards or calories, which may be particularly useful for managing dietary restrictions or preventing overfeeding. Additionally, or alternatively, the settings may include a quiet hours parameter, which may specify a time and duration during which rewards are not to be dispensed, to align with the household's routine and to avoid disturbing periods of rest or inactivity.

In one embodiment, the reward protocol may define a setting of the rewards controller 222 that may include specifying different dispensing timing and frequencies to accommodate the cat's established scratching habits. For example, in a partial reinforcement schedule setting, rewards may be dispensed for some but not all instances of scratching, which may help maintain the cat's interest in the scratcher without over-reliance on treats. A variable ratio schedule setting may dispense rewards unpredictably after a particular average number of scratches has been achieved, which may be effective in maintaining desired scratching behavior. In a continuous reinforcement schedule setting, rewards may be dispensed after every scratch. This continuous reinforcement schedule setting may be particularly useful during the initial stages of training to establish a strong association between the scratching behavior and the reward.

In embodiments, the adjustable settings of the reward protocol may enable a dynamic and responsive experience, where the rewards controller 222 may adapt the reward protocol to the evolving and changing requirements and preferences of both the cat and the owner. This level of customization and personalization may operate to ensure that the smart cat scratcher 100 remains an effective device for promoting, encouraging, and ensuring appropriate scratching behavior while also considering the well-being and satisfaction of the cat.

The rewards controller 222 may autonomously determine (e.g., based on AI model) a maintenance protocol for dispensing the rewards to maintain the appropriate scratching behavior. The maintenance protocol may incorporate a variety of variables to maximize the success of maintaining the behavior for each individual cat. These variables may include the reward schedule (e.g., timing and frequency of the reward), reward criteria (e.g., what behavior gets rewarded), reward type, and/or reward intensity. In embodiments, the maintenance protocol may be similar or may be equivalent to the expert training level of the training protocol described herein. The determination of the maintenance protocol may be based on target daily calorie intake, observed behavior, physical condition, and personality, including the cat's individual reward motivation: liking of food vs. catnip/silver vine vs. play. For example, with respect to the management of the reward schedule, when the cat has mastered the scratching behavior and the focus is on maintaining it, it will be important to find a partial reinforcement schedule that does not overfeed the cat with treats by offering more than required to maintain the behavior, nor under-reward the cat so that it receives so few treats that it loses interest in scratching. The rewards controller 222 could intelligently identify the ideal reward pattern based on the individual cat. If the cat then ever regresses and scratches less, rewards controller 222 would notify (e.g., via application manager 228) the owner to flag this (as it could be health-related) but also temporarily adjust to a higher frequency or intensity of the reward to re-engage the cat and may then determine a more optimal reward schedule to avoid future regression. In that sense, rewards controller 222 represents a dynamic system that continuously and autonomously optimizes.

In embodiments, the rewards controller 222 may be configured to autonomously determine the settings, rules, parameters, etc., for implementing the maintenance protocol of the reward protocol. The maintenance protocol may be configured to determine the dispensing of rewards to maintain the established scratching behavior of the cat. In embodiments, the maintenance protocol may leverage or employ AI models and/or algorithms that take into account a variety of factors, including, for example, the cat's target daily calorie intake, observed behavior, physical condition, and/or personality traits such as the individual cat's reward motivation. The AI model may determine whether a cat is more motivated by food, catnip or silver vine, or play, and adjust the maintenance protocol accordingly.

In embodiments, the rewards controller 222 may dynamically and continuously monitor and adjust the maintenance protocol, proactively optimizing the reward schedule and other variables based on the cat's ongoing behavior and changing circumstances. This functionality ensures that the cat's scratching behavior is maintained effectively over time.

For example, once a cat has mastered the desired scratching behavior, the rewards controller 222 may implement a partial reinforcement schedule as part of the maintenance protocol. Under this partial reinforcement schedule, not every scratch may be rewarded, but the rewards may be dispensed intermittently. This partial reinforcement schedule may be configured to avoid overfeeding the cat with treats by offering more than is actually required to maintain the scratching behavior, while also ensuring that the cat does not receive so few treats that it loses interest in scratching the smart cat scratcher 100. The rewards controller 222 may intelligently identify the ideal reward pattern for each individual cat, taking into consideration the cat's preferences and the effectiveness of different reward schedules.

In some embodiments, in response to a determination that the cat's scratching behavior has regressed (e.g., less frequent or less intense scratching and/or the cat is to a greater degree scratching surfaces that the cat should not be scratching), the rewards controller 222 may notify the owner (e.g., via the functionality of the application manager 228). In embodiments, the notification may operate to inform the owner that the cat has regressed, and/or may operate to flag potential health-related issues that may be affecting the cat's behavior. In response to such a regression, the rewards controller 222 may temporarily adjust to a higher reward frequency, and/or may adjust to a higher value reward type, and/or a higher reward intensity, and/or or may loosen the reward criteria to re-engage the cat in the scratching activity and may then determine a more optimal reward protocol to avoid future regression. Additionally, or alternatively, in response to a regression, the rewards controller 222 may initiate engagement activities through the functionality of the engagement manager 226 and the engagement module 122 to encourage the cat to interact with the smart cat scratcher 100. These activities may include interactive play, visual stimuli, or auditory cues that attract the cat's attention and promote the use of the scratching surface. Additionally, or alternatively, in response to a regression, the rewards controller 222 may re-enroll the cat in the training protocol if a decline in appropriate scratching behavior is detected, reinforcing the training and ensuring consistent use of the smart cat scratcher.

It is noted that, in embodiments, one or more cameras (e.g., in one or more sensors 120) may be utilized to detect and monitor inappropriate scratching behavior by the cat. The one or more cameras may be configured to capture video footage of the surrounding area, which may be analyzed by the scratcher controller using computer vision and machine learning algorithms. These algorithms may be trained to recognize and distinguish between appropriate scratching on the smart cat scratcher and inappropriate scratching on furniture or other household items. If inappropriate scratching is detected, the scratcher controller may determine that the cat's scratching behavior has regressed and may activate mitigation functionality (e.g., as described above) in response.

In some embodiments, the rewards controller 222 may determine whether to dispense a reward based on the identity of the cat (e.g., in cooperative operation with the cat recognition manager 224). The cat recognition manager 224 may employ various identification techniques, such as RFID microchip reading, scannable cat collars, visual recognition through cameras, or behavioral analysis, to accurately identify individual cats within a multi-cat household. Once the identity of the cat is established, the rewards controller 222 may access a profile specific to that cat, which may include the cat's training history, reward preferences, and dietary considerations and restrictions.

In embodiments, the rewards controller 222 may tailor the reward protocol to the identified cat, dispensing rewards that are not just based on the scratching activity, but also on the specific requirements and preferences of the cat. For example, most cats will have a limitation on how many treats they may eat, and in those cases, the rewards controller 222 may operate to ensure that the cat does not receive more than the allotted number of treats, regardless of its scratching activity. Similarly, if a cat is known to have a preference for a specific type of reward, such as a particular flavor of treat or a non-food item like catnip, the rewards controller 222 may dispense that preferred reward to maximize the positive reinforcement effect.

In some embodiments, the rewards controller 222 may also implement and/or manage a manual treat dispensing mode, which may be activated through a manual activator physically on the smart cat scratcher 100 and/or through the connected application on the user terminal (e.g., user terminal 130). In the manual treat dispensing mode, the determination to dispense a reward may be based on a manual trigger by the user, rather than the automated detection of scratching activity. This feature may allow the user to provide immediate positive reinforcement at their discretion, which may be particularly useful during interactive training sessions or when the user wishes to reward the cat for behavior observed directly.

Additionally, or alternatively, the rewards controller 222 may control the amount of reward that is dispensed, allowing the user to specify the size of the treat or the quantity of non-food rewards such as catnip or silver vine. In some embodiments, the rewards controller 222 may be configured to dispense a mix of different types of rewards that hold varying amounts of value to the cat, such as one or more pieces of kibble for a scratch of moderate quality or one or more treats for a scratch of a highest quality, where treats may hold more value to the cat than kibble. This control over the dispensing of rewards may be adjusted through the connected application, providing the user with the flexibility to manage the cat's dietary intake and to customize the reward experience to the cat's preferences and the training objectives. This functionality may enhance the interactive aspect of the smart cat scratcher 100, providing a more engaged relationship between the cat and its owner.

For example, in some embodiments, the rewards controller 222 may control the amount of reward that is dispensed based on the quality of the scratching activity detected by the sensor(s) 120. For example, the rewards controller 222 may be configured to dispense varying amounts of treats, such as, in one non-limiting example, dispensing one treat for a scratch of moderate quality or five treats for a scratch of a highest quality. This differentiation in reward quantity serves to provide a proportional response to the quality of the cat's scratching, encouraging the cat to engage in more vigorous or appropriate scratching behavior. Of course, it is noted that the above example of the number of treats dispensed based on the quality of the scratching activity is not intended to be limiting but is provided for demonstration purposes. Indeed, the number of treats dispensed for each quality level of the scratching activity may be defined or set by a user (e.g., through the connected app) or may be based on a default setting, in which the setting may specify the number of treats to be dispensed for each level of quality of the scratching activity, or may be autonomously defined by the rewards controller 222, based on the cats target calorie intake or other characteristics. In another example, the rewards controller 222 may be configured to dispense varying types and/or durations of interactive play based on the quality level of the scratching activity.

The determination of the quality level of a scratch may be based on an analysis of various characteristics such as the depth, duration, intensity, and pattern of the scratches. A higher quality scratch, which may be characterized by greater depth and duration, may trigger the dispensing of a larger reward. Conversely, a less intense scratch may yield a smaller reward. This functionality of variable reward dispensing allows for a more accurate and precise approach to training, where the cat is not just rewarded for scratching, but is rewarded in a manner that reflects the quality of its scratching activity.

Implementing a reward protocol that is sensitive to the quality of scratching, such as implemented by the rewards controller 222, provides a more engaging and motivating experience for the cat, which may accelerate the learning process, help maintain learned behavior, and enhance the effectiveness of the smart cat scratcher 100. This functionality also allows owners to have greater control over the reward protocol, as the owner may set the thresholds for what constitutes different quality levels of scratches and the corresponding rewards through the connected application.

In embodiments, the reward protocol of the rewards controller 222 may include a training protocol, configured to guide, encourage, and manage the cat through various stages of learning appropriate scratching behavior, from initial introduction to the smart cat scratcher 100 to the reinforcement and maintenance of the desired behavior. In embodiments, the training protocol of the rewards protocol may be implemented and managed by the functionality of the training manager 223. Further details of the training protocol will be discussed in more detail with respect to the functionality of the training manager 223.

In embodiments, the rewards controller 222 may dispense a reward by sending one or more signals to initiate the dispensing action. For example, upon determining that a scratch has met the established criteria for quality, the rewards controller 222 may send a signal to the food-based reward dispenser 115, instructing it to release a food-based reward. This signal may activate the dispensing mechanism within the food-based reward dispenser 115, which may include an actuator moving a gate, door, or other dispense control device, to allow the treats, regular food (e.g., kibble), catnip, silver vine, and/or any other food-based reward to be dispensed out of the container of the reward dispenser 115 and made accessible to the cat, offering immediate positive reinforcement for the scratching behavior.

In additional or alternative embodiments, the rewards controller 222 may send a signal to the engagement module 122 to dispense an interactive reward. This may involve activating a light show, a moving toy, or an auditory cue that serves as a form of play and interaction for the cat. The engagement module 122, upon receiving the signal from the rewards controller 222, may execute the specified engagement activity, providing the cat with a stimulating and rewarding experience that encourages further interaction with the smart cat scratcher device 100. These interactive rewards can help conduct training beyond the restrictions of daily calorie limits. Interactive rewards can be particularly effective for cats that are less motivated by food or for owners who wish to provide a variety of reward types to maintain their cat's interest in the scratching surface 150.

The training manager 223 may be configured to implement and manage the training protocol of the rewards protocol. In embodiments, the training manager 223 may implement and manage the training protocol of the rewards protocol by leveraging one or more AI models configured with functionality to facilitate the training manager applying a structured approach that includes a series of training levels, each with specific objectives, reward schedules, and/or other variables tailored to the cat's progress.

In embodiments, the training manager 223 may initiate the training protocol by first establishing a baseline of the cat's natural scratching behavior and preferences. This initial assessment may involve monitoring the cat's interaction with the smart cat scratcher 100 without dispensing rewards, to understand the cat's innate tendencies. Based on this assessment, the training manager 223 may then set the initial training parameters, such as the criteria for which to dispense a reward, reward schedule, reward intensity, and/or type of rewards to be dispensed, and the criteria for progressing to subsequent training levels.

At this initial stage, the training manager 223 may reward any interaction by the cat with the smart cat scratcher 100, whether with the scratching surface 150 or any other portion of the smart cat scratcher 100. As the cat begins to engage with the smart cat scratcher 100 more consistently, the training manager 223 may implement a continuous reinforcement schedule, where every appropriate scratch is rewarded. This immediate and consistent positive reinforcement may operate to quickly establish the association between scratching the designated surface (e.g., scratching surface 150) and receiving a reward. As the cat demonstrates consistent use of the smart cat scratcher 100, the training manager 223 may gradually transition to a partial reinforcement schedule, where rewards are dispensed less predictably to strengthen the learned behavior.

Throughout the training process, the training manager 223 may adjust the training protocol based on the cat's performance and adaptability. If the cat shows a slow learning curve, shows signs of regression or loss of interest, the training manager 223 may modify the reward schedule, and/or provide higher value rewards, and/or increase the reward intensity, and/or relax the reward criteria, and/or introduce new forms of engagement to reinvigorate the cat's motivation. Conversely, if the cat excels in the training, the training manager 223 may increase the challenge by requiring more complex or sustained appropriate scratching behavior for rewards, or if the appropriate scratching behavior is established it may focus on maintaining the behavior in a partial reinforcement schedule.

In embodiments, the training manager 223 may also provide feedback to the owner through the connected application, allowing the owner to track their cat's progress and participate in the training process. This collaborative approach ensures that both the cat and the owner are actively involved in the training and may foster a stronger bond between the cat and the owner.

In embodiments, the training protocol managed by the training manager 223 may incorporate a variety of variables to customize the training experience for each individual cat. These variables may be combined to form a training protocol that adapts to the cat's current stage in the training process, ensuring that the training is effective and engaging.

One of the variables that make up the training protocol includes the behavior that gets rewarded (e.g., the reward criteria). The reward criteria may range from rewarding good scratches that meet a set quality threshold to acknowledging short and weak scratches, or even the mere act of a paw touching the scratching pad without active scratching. The goal is to gradually shape the cat's behavior by reinforcing increasingly closer approximations to the desired scratching behavior.

Another variable includes the intensity of the reward dispensed by the rewards controller 222. Through the functionality of the training manager 223, the smart cat scratcher 100 may be configured to dispense a single treat for a moderate-quality scratch or multiple treats, such as five at a time, for a high-quality scratch. Additionally, the training protocol may include the provision of a “jackpot” reward—a sparingly used, high-intensity reward that may be particularly effective in reinforcing and maintaining desired behavior. The jackpot reward is akin to a large payout at a casino and serves as a powerful motivator for the cat.

The schedule of reinforcement (e.g., the timing and frequency of rewards) may be a variable within the training protocol. Continuous reinforcement may be used initially, rewarding the cat every time the desired behavior is demonstrated. As the cat's behavior becomes more consistent, the training manager 223 may shift to partial reinforcement, where rewards are given after a set number of desired behaviors, such as an average of 5 or 10 scratches. This may help to establish a stronger and more durable scratching habit.

Yet another variable that may be customized within the training protocol includes the type of reward. While food-based rewards may be common, the smart cat scratcher 100 may also or alternatively incorporate interactive rewards, such as engaging the cat with a light show or a moving toy. This variety in reward types may operate to cater to the diverse preferences of cats, may enhance the overall training experience, and may enable training outside of the constraint of cats' daily maximum calorie intake.

By combining these variables (e.g., reward criteria, reward intensity, reward schedule, and reward type), the training manager 223 may create a dynamic and personalized training protocol. This training protocol may be applied and adjusted to meet the individual training level and preferences of each cat, as well as other factors, including, for example, the cat's target daily calorie intake, observed behavior, physical condition, and personality traits such as the individual cat's reward motivation.

In a particular embodiment, the training manager 223 may be configured with functionality to create, apply, optimize, and manage the training protocol for the individual cat. In this embodiment, the training manager 223 may implement the training protocol with various training modes, including, without limitation, a beginner mode, and advanced mode, and expert mode. In this embodiment, the training manager 223 may be configured to autonomously assess the cat's current training level and adjust the categorization as the cat progresses in its learning journey. The training manager 223 may continuously learn from the cat's interactions with the smart cat scratcher device 100 and may adjust the training approach to align with the cat's progression and behavior.

In the beginner mode, the training manager 223 may provide rewards for any interaction with the smart cat scratcher 100, not limited to scratches. This could include dispensing a reward when the cat is merely in proximity to the scratcher or for the lightest contact with the scratching surface 150. This mode may be configured to encourage initial engagement with the smart cat scratcher 100 and to build a positive association with the smart cat scratcher 100.

As the cat becomes more accustomed to the scratcher, the training manager 223 transitions the cat to an advanced mode. In the advanced mode, the cat may receive a reward for every scratch, even for low quality scratches (e.g., scratches of low duration and/or weak strength). In the advanced mode, the focus may be on reinforcing the scratching behavior itself, with the reward being contingent on the act of scratching the scratching surface 150 rather than other forms of interaction.

In the expert mode, the training manager 223 may implement a partial reward schedule. An expert cat may receive a reward for every few scratches (e.g., the cat may receive a reward for every 5th scratch), and/or the rewards may be based on the quality of the scratches. For example, the training manager 223 may set a quality threshold, and the cat may receive a reward for scratches that are stronger and last longer than a specified duration. In some embodiments, the expert mode may be configured to maintain the cat's interest in the smart cat scratcher 100 while preventing over-reliance on treats and promoting sustained, high-quality scratching behavior. As noted above, in some embodiment, the expert mode and the maintenance mode may be similar to each other, may be equivalent, or may be the same mode.

In embodiments, the training manager 223's functionality to adapt or adjust the training protocol to the individual cat's learning curve and behavior ensures a more effective and engaging training experience. This customizable and tailored approach may help develop a positive scratching habit from the cat.

The cat recognition manager 224 may be configured to identify and/or to distinguish between various cats and/or various animals in a household. In some embodiments, the cat recognition manager 224 may utilize advanced image processing, machine learning algorithms, and/or AI models to distinguish between cats and other pets, such as dogs, ensuring that the reward system is specifically tailored to the feline users of the device. This functionality may be useful to prevent dogs or other non-target animals from inadvertently triggering the treat dispensing mechanism, which could lead to overfeeding, or the depletion of treats intended for the cat.

In multi-cat households, the cat recognition manager 224 may be configured to “tell” different cats apart from each other. This functionality may be achieved through image-based visual recognition techniques that analyze features such as fur patterns, size, and shape, and/or through RFID microchip reading, scannable cat collars, and/or behavioral analysis. By identifying individual cats, the cat recognition manager 224, such as in cooperative operation with the rewards controller 222, may determine whether a reward may be dispensed to a particular cat. In addition, or in the alternative, identifying individual cats may enable the cat recognition manager 224 to, in cooperative operation with the training manager 223, apply personalized training protocols that are optimized for each cat's learning pace, behavior, and preferences. This personalization extends to controlling the treat intake for each cat, allowing owners to manage dietary restrictions and prevent overfeeding, among other features.

In embodiments, the cat recognition manager 224 works in conjunction with the rewards controller 222 and the training manager 223 to ensure that each cat receives a training experience that is not just effective, but also safe and enjoyable. For example, if one cat has mastered the use of the scratcher while another is still learning, the cat recognition manager 224 may facilitate ensuring that the expert cat does not consume all the treats, leaving the beginner cat without the positive reinforcement it requires. Additionally, by recognizing individual cats, the cat recognition manager 224 may provide valuable data to the owner through the connected application, such as tracking each cat's progress, adjusting training levels, and monitoring treat consumption.

It is noted that the integration of the functionality of the cat recognition manager 224 into the smart cat scratcher 100 represents a significant technological improvement in pet training technology. Such functionality allows for a level of customization and control that is not possible with traditional, non-intelligent scratchers. With the ability to recognize and remember each cat, the smart cat scratcher 100 becomes a central part of a tailored training and reward system that caters to the individuality of each pet, enhancing the bond between cats and their owners and promoting a harmonious living environment for all. It also renders the device usable in out-of-home settings, such as animal shelters or breeders, where it may enable multiple cats to jointly use one device, making it a more cost-effective and practical solution than requiring one smart cat scratcher per cat.

The engagement manager 226 may be configured to manage the interaction of the cat with the smart cat scratcher 100 via the engagement module 122. In embodiments, the engagement manager 226 may be configured to enhance the cat's experience by providing interactive rewards and activities that attract or encourage the cat to interact with the smart scratcher 100. The engagement manager 226 may determine to send one or more signals to the engagement module 122 to dispense an interactive reward to the cat in response to scratching activity, leveraging the functionality of the rewards controller 222. Additionally, the engagement manager 226 may activate interaction activities to encourage the cat to interact with the smart cat scratcher 100.

For example, in response to a determination (e.g., by the engagement manager 226) that the cat has not interacted with the smart scratcher for longer than a threshold period of time (e.g., a number of hours or a number of days), the engagement manager 226 may send a signal to the engagement module 122 to activate an interactive activity. The interactive activity may include engaging lights, lasers, toys, and/or sounds such as bird chirping or the owner's voice, to draw the cat's attention and encourage interaction with the smart cat scratcher 100. The engagement manager 226 may be configured to maintain the cat's interest and promote consistent use of the scratcher, which is beneficial for both the cat's well-being and the preservation of household furniture.

In some embodiments, the engagement manager 226 may leverage the camera to monitor the room and manage the scratching behavior of the cat. For example, if the engagement manager 226 detects that the cat is in the act of inappropriate scratching activity (e.g., scratching furniture, or another household item), the engagement manager 226 may cause the speaker to play a deterring sound to stop the inappropriate scratching activity. Additionally, or alternatively, the engagement manager 226 may actively engage in a “cat-attracting” protocol when the engagement manager 226 predicts that the cat is about to engage or is in the process of engaging in inappropriate scratching activity. In embodiments, the “cat-attracting” protocol may involve proactively dispensing a treat, dispensing catnip, engaging in interactive play, or playing a bird-sound to attract or redirect the cat to the smart cat scratcher 100. In some embodiments, through observation and application of AI models, the engagement manager 226 may learn over time when a cat is most likely to engage in inappropriate scratching behavior (e.g., whenever owner leaves the home or every morning around a certain time) and may be configured to influence and redirect the cat before inappropriate scratching occurs.

The behavior manager 227 may be configured to monitor the physical, temperamental, and/or personality behaviors of the cat to detect any changes that could indicate health or safety issues, both physical and mental. By analyzing the frequency, intensity, and quality of the cat's scratches, the behavior manager 227 may identify deviations from established patterns that may signal potential problems. For example, if a cat that typically scratches vigorously and frequently begins to scratch less often or with less force, this may be indicative of discomfort, stress, or a decline in health.

In embodiments, the behavior manager 227 may determine and maintain a baseline understanding of what constitutes “normal” scratching behavior for each cat in the household, including the typical amount and quality of scratches. This baseline may be established through historical data and ongoing observation, allowing the behavior manager 227 to quickly recognize when a cat's behavior falls outside of its usual pattern. For example, if a cat's scratches become noticeably shallower or shorter in duration, it may suggest that the cat is experiencing pain or discomfort in its paws or claws.

In addition to monitoring scratching behavior, the behavior manager 227 may also assess the cat's physical posture, weight distribution, and balance (e.g., this may be especially significant in the horizontal configuration of the smart cat scratcher 100). Abnormalities or changes in these areas may indicate a range of issues, from musculoskeletal problems to neurological conditions. By leveraging the camera and applying AI models, the behavior manager 227 may analyze the cat's posture during scratching activities. In embodiments, this analysis may reveal subtle changes, such as the cat favoring one paw over another or not stretching as high as usual, which may be symptomatic of underlying health issues.

Upon detecting any such behavioral changes, the behavior manager 227 may alert the owner of the potential issues (e.g., through the functionality of the application manager 228). This alert system may enable timely intervention by the owner, who may take appropriate action, such as consulting a veterinarian or adjusting the cat's environment to better accommodate its changing needs. Through this proactive monitoring and alerting process, the behavior manager 227 may contribute to maintaining the health and well-being of the cat, while also providing peace of mind to the owner.

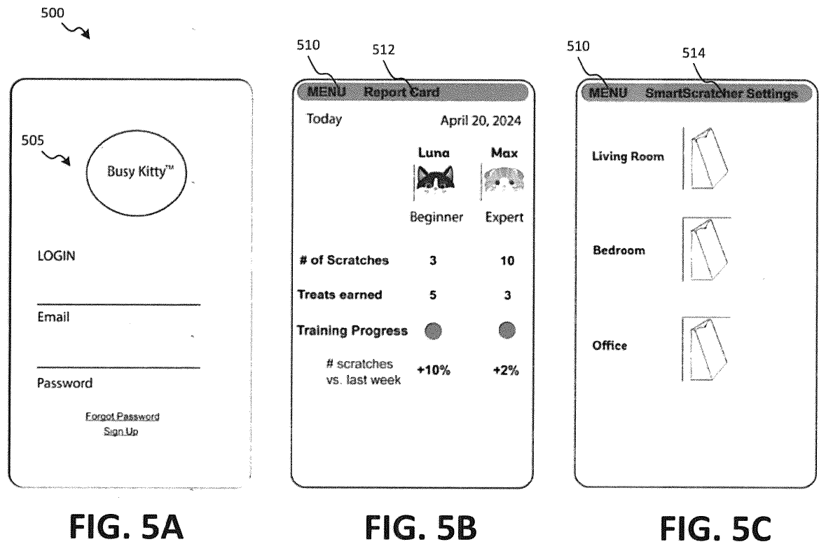

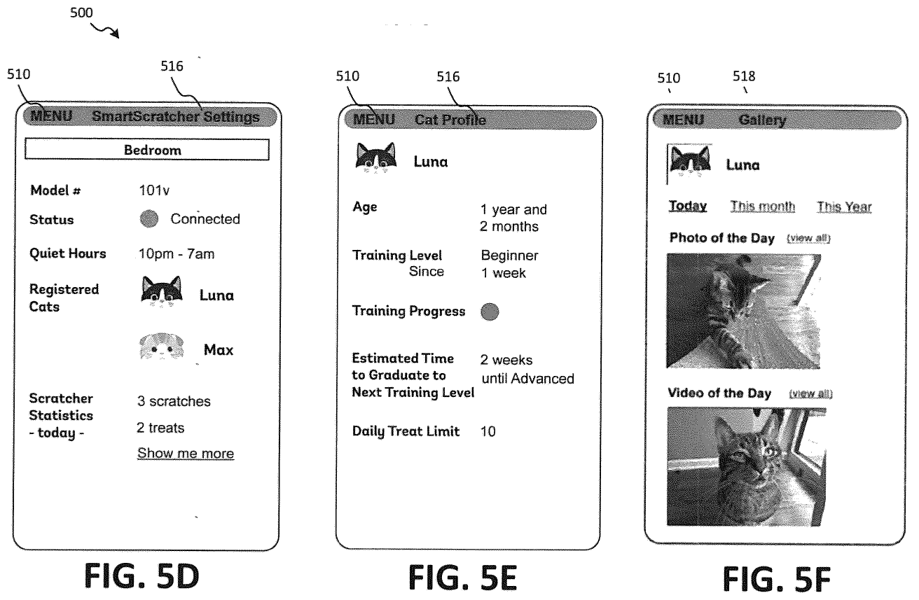

The application manager 228 may be configured to provide and manage the functionality of the connected app, which may be presented and accessible via the user terminal 130. This connected app may operate as an interface for the user to leverage and manage the functionality of the smart cat scratcher 100. Through the app, the user may specify various settings for the operation of the smart cat scratcher, tailoring the device to meet the specific requirements of their cat and household, and to view and receive various information regarding the operations of the smart cat scratcher 100 and/or progress of the cat(s). The functionality of the application manager 228 and the connected app will be discussed with further reference to FIGS. 5A-5F. FIGS. 5A-5F show various views of exemplary interface windows of a connected app 500 illustrating the functionalities and settings available to the user for managing and accessing the functionality of the smart cat scratcher in accordance with embodiments of the present disclosure.

As shown in FIG. 5A, connected app 500 may include a login screen operating as the gateway for users to access the various functionalities of the smart cat scratcher (e.g., the smart cat scratcher 100). On the login screen, users may be prompted to enter their credentials to log in and manage their cat's profiles, smart cat scratcher settings, and/or view scratching activity. For new users, the screen may offer the option to create an account, guiding the new user through the process of registering and setting up their profile within the connected app 500. This initial step may operate to ensure that each user's experience is personalized and secure, providing a foundation for the interactive and engaging features that the connected app 500 offers to enhance the relationship between cats and their owners. In addition, the signup feature may allow vendors to collect first-party consumer data, which may be used to enhance customer service, provide personalized recommendations, and improve product offerings. The data collected may also be valuable for understanding consumer behavior and preferences, leading to better-targeted marketing and product development strategies.

As illustrated in FIGS. 5B-5F, the connected app 500 may feature a menu 510 that may provide users with a variety of options to fully leverage the capabilities of the app. In embodiments, the menu 510 may operate as a central hub for accessing the different functionalities, enabling users to easily navigate through the connected app 500's features. Through the menu 510, users may manage their cat's profiles, adjust settings, monitor scratching activity, and/or may access the gamification elements that make the training process more engaging. The menu 510 may be configured to be intuitive and user-friendly, ensuring that all the powerful features of the connected app 500 are readily available at the user's fingertips, enhancing the interactive experience with the smart cat scratcher.

As shown in FIG. 5C, the menu 510 may include a smart scratcher settings option 514. The smart scratcher settings option 514 may provide functionality for customizing various aspects of the smart cat scratcher's operation. For example, the smart scratcher settings 514 may include an option for users to specify the location of the smart cat scratcher within their home, such as designating it to be in the living room, bedroom, office, or any other preferred area. This may help users to track where the cat is engaging in scratching activity and to ensure that the smart cat scratcher is placed in the cat's favorite or high-traffic areas or areas where destructive scratching has been occurring. In a household where more than one smart cat scratcher is connected to the app, the smart scratcher settings 514 may also help keep track of their placement around the house. To help cater towards cats' dietary requirements, the user may input the calorie information of the treats and/or kibble the user fills into the smart cat scratcher's reward refill slot 315. With this information, the smart cat scratcher rewards controller 222 may autonomously manage the food-reward dispensing to each cat's daily calorie limit. In some embodiments, the smart cat scratcher may be located in a user's home, or any other location such as in an animal shelter, where the smart cat scratcher may be used for scratch training in accordance with embodiments of the present disclosure.

In embodiments, as shown in FIG. 5D, the smart scratcher settings may include settings that enable users to specify the model of the smart cat scratcher being used, which may be useful for troubleshooting and receiving targeted support. In embodiments, the smart scratcher settings may include an indication of the status of the smart cat scratcher, such as whether it is currently connected to the network or offline, ensuring that the user is always aware of the device's connectivity and functionality.

In embodiments, the smart scratcher settings may include a setting for defining quiet hours, which may include a period of time during which the smart cat scratcher is not to dispense rewards (e.g., treats or other food-based rewards, and/or interactive rewards such as interactive play, toys or sounds). This feature may be particularly useful for maintaining a peaceful environment during rest periods or nighttime. The smart scratcher settings may also include functionality for registering new cats and/or showing a list of cats already registered.

In embodiments, the smart scratcher settings may include scratcher statistics, which may provide users with insights into their cat's daily scratching activity. These scratcher statistics may include the number of scratches made by the cat on that day, the number of rewards earned, and/or other relevant metrics. By having access to this data, users may monitor their cat's engagement with the smart cat scratcher and adjust the training protocol as appropriate to encourage consistent and healthy scratching behavior.

As shown in FIG. 5B, the menu 510 may include a report card option 512, configured to provide a detailed report and analysis of each cat's interaction with the smart cat scratcher. In embodiments, the report card may enable owners to track the progress and well-being of their feline companions over configurable periods, such as daily, weekly, or monthly intervals.

In embodiments, the report card may provide a snapshot of the training level of each cat, indicating whether the cat is a beginner, intermediate, or an expert in using the scratcher. For example, in the example illustrated in FIG. 5B, two cats have been registered, namely Luna and Max. In this example, Luna may be indicated as a beginner while Max is indicated as an expert scratcher. It is noted that although this example shows two cats, less or more cats may be registered, in which case the report card may include information on all or a subset of the registered cats.

In embodiments, the report card may provide an indication of the average number of scratches for the selected period, giving owners insight into their cat's scratching habits and activity levels. In this example, Luna performed three scratches today and Max performed ten scratches. In some embodiments, the number of scratches shown in the report card may include only scratches that have exceed a quality threshold. In some embodiments, the report card may also provide an indication of the quality level of each scratch, although not illustrated in FIG. 5B. In embodiments, the indication of the quality level of each scratch may include a color code (e.g., green for excellent, yellow for medium, red for bad, etc.), may include a number (e.g., 0 for bad and 10 for excellent), or may simply include a textual indication of the quality (e.g., “good,” “bad,” “excellent,” etc.).

In embodiments, the report card may provide an indication of rewards earned during the period of time. For example, the report card may provide an indication of treats earned during the period of time, which may allow owners to monitor the rewards their cat has received and ensure they align with dietary guidelines. In this example, Luna has earned five treats today and Max has earned three treats. In some embodiments, the indication of rewards earned during the period of time may include an indication of the number and/or duration of interactive rewards earned by each cat.

In embodiments, the report card may include a visual indicator of training progress. This feature may use a color-coded system (e.g., green for satisfactory progress, yellow for slower progress, and red for a lack of progress) to give owners an at-a-glance understanding of how well each cat is doing. This immediate feedback may prompt owners to adjust training methods or provide additional encouragement as needed.

In some embodiments, the report card may provide a comparison of the number of scratches in the current period to a previous period. For example, in the example illustrated in FIG. 5B, the report card for Luna and Max provides a ratio of the number of scratches performed today to an average daily number of scratches from the last week. This ratio may provide a view of the cat's engagement with the scratcher, highlighting trends and changes in behavior that may warrant further attention. For example, Luna's ratio for today is 10%, showing that Luna's engagement today is significantly better than last week's engagement. On the other hand, Max's ratio for today is 2%, showing that Max's engagement today is mostly consistent with last week's engagement, which may indicate successful maintenance of learned behavior at his expert-level.

As noted above, the connected app 500 may allow the user to create detailed profiles for each cat, including the cat's name, age, weight, breed, and a picture or icon. The user may also input the cat's level of scratcher experience, which the smart cat scratcher may use to adjust the training protocol accordingly. Additionally, the connected app 500 may enable the user to set a daily treat limit, kibble limit, and/or calorie limit, and to track the number of treats and/or amount of kibble rewarded per cat, ensuring that the cat's dietary requirements are met without overfeeding. In embodiments, each user may create one profile per cat, allowing for individualized management and monitoring of each cat's interaction with the smart cat scratcher. This level of personalization ensures that the training and reward system is optimized for each cat's behavior, promoting a more effective and enjoyable training experience.

In embodiments, as shown in FIG. 5E, the menu 510 may include a cat profile option 516, configured to provide a detailed view of the profile of each registered cat. In embodiments, the cat profile may include an identity of the cat, which may include the cat's name (e.g., Luna in this example), a photograph, and any distinctive markings or characteristics that may help in identifying the cat, especially in multi-cat households. The cat profile may also include the age of the cat (e.g., 1 year and 2 months for Luna in this example), providing context for the cat's behavior and potential training requirements, as younger cats may learn differently than older ones.

In embodiments, the cat profile may include the training level of the cat, which may indicate whether the cat is a beginner, intermediate, or expert in using the smart cat scratcher. In the example illustrated in FIG. 5E, Luna is a beginner scratcher. It is noted that the training level is not static, as it may change. In embodiments, the cat profile may show and indication of how long the cat has been at the current training level, offering insight into the cat's learning pace and potential areas where additional encouragement or adjustment in training methods may be beneficial. For example, as shown in FIG. 5E, Luna has been a beginner for one week. In embodiments, an indication of the training progress may be included in the cat profile, such as a visual indication (e.g., a color-coded indication), allowing for quick assessment of the cat's advancement through the training levels.

In embodiments, the cat profile may include an estimated time to graduate to the next training level. This estimate may be based on the cat's current rate of progress and may help users set realistic expectations and goals for their cat's training journey. In this example, Luna is estimated to graduate to the advanced level in two weeks. In embodiments, the cat profile may include an indication of the daily treat limit (e.g., 10 treats for Luna in this example), daily kibble limit (e.g., 1 cup), and/or a daily total calorie limit, which may be a customizable setting within the cat profile configured to manage the cat's dietary intake, ensuring that the cat receives an appropriate number of treats and/or kibble in alignment with its health and nutritional requirements.

As shown in FIG. 5F, the menu 510 may include a gallery option 518, configured to provide a visual and interactive dimension to the cat scratching experience. In embodiments, the functionality of gallery option 518 may be configured to showcase a curated selection of images and videos that capture the cat's scratching moments, adding a layer of enjoyment and engagement for the user. In one embodiment, the gallery may present a “Photo of the Day” and/or “Video of the Day,” highlighting the cat's notable scratching achievements or amusing antics. These daily features encourage users to regularly interact with the app and look forward to new content showcasing their cat's activities. The curated images may span various periods of times, such as daily, monthly, yearly, a customizable period of time, etc. These daily features may also get sent to the user in form of push notifications at those various points in time.

In embodiments, the gallery option 518 may include functionality to generate (e.g., through the functionality of application manager 228) and/or to present compilations of the “best scratches”, where the connected app 500 may automatically aggregate the top scratching moments over a period of time (e.g., daily, monthly, yearly, a customizable period of time, etc.) over the course of time in a certain training level (e.g., best scratches in advanced training level), or for certain anniversary milestones (e.g., one month or one year of training with the smart cat scratcher). These compilations may include a series of images or a montage of videos that exhibit the cat's progress, technique, and enthusiasm for scratching. These compilations may be accessible in the app and may get sent out via push notifications to the user at pre-determined points in time (e.g., daily, monthly, yearly, etc.), and at milestones like training level graduation and training anniversaries. By providing a visual record of the cat's scratching behavior, the gallery option 518 may enable users to observe patterns, celebrate improvements, and share their cat's accomplishments with friends and family.

In embodiments, to further gamify the scratching experience, the connected app 500 may send push notifications to the user when the cat engages in scratching activity. These notifications may include a live view option, allowing the user to watch the scratching session in real-time, fostering a sense of connection and immediacy. In embodiments, the gamification may extend to the unlocking of badges for different training levels, such as “BeginnerCat,” “ProCat,” and “MasterScratcher,” in one particular non-limiting example. These badges may serve as fun milestones that recognize the cat's progress and provide a sense of achievement for both the cat and the owner. In some embodiments, the achievements may come with special rewards. For example, as a cat unlocks an achievement, a special treat, special interactive play, a jackpot, etc., may be dispensed. There may be incentives for the owner as well when their cat unlocks the expert-level/“MasterScratcher” badge, such as coupons or a free sample of cat treats. In embodiments, the connected app 500 may provide access to a library of scratch photos and recordings, creating a repository of the cat's scratching history. Users may browse through this library to view the variety and evolution of their cat's scratching behavior.

In embodiments, the app may provide functionality for rating the scratches, from “barely touched but got away with it” to “A+ big scratch,” introducing a playful and competitive element to the training process. This rating system may motivate users to engage more actively in their cat's training, striving for higher-quality scratches. Additionally, the connected app 500 may compile a “best of scratches” (e.g., at a configurable time, such as 6 PM, 7 PM or any other time of the day), and at specific training milestones like advancing to the expert level, and after certain anniversary milestones (like one month or one year of training with the smart cat scratcher), classifying scratches with ratings like “A+ amazing scratch,” “B-scratched for a treat, mediocre motivation,” or “C-barely scratched but got away with it.” These types of recaps provide a fun and engaging summary of the cat's scratching performance.

In embodiments, the connected app 500 may include functionality to provide daily statistics of scratches, providing users the ability to access detailed scratching statistics. This data may reveal whether the cat is using the scratcher more, the same, or less than before, the number of scratches per day, and how many rewards have been dispensed, among other statistics. In some embodiments, the connected app 500 may include a manual reward dispensing function, which may allow the user to activate a reward, such as a food-based or interactive reward, manually, without the cat having to scratch. This manual reward dispensing function may provide users with the flexibility to reward their cat for other positive behaviors or simply to offer a treat as a sign of affection.

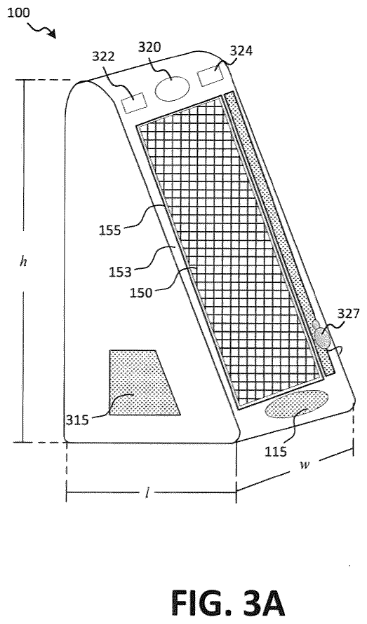

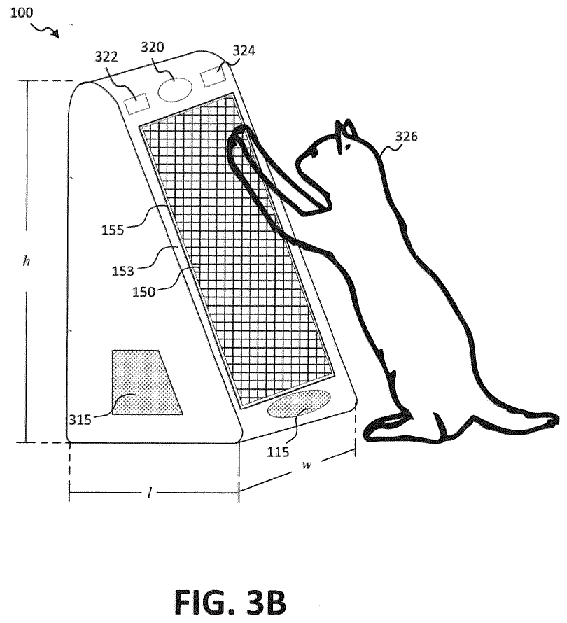

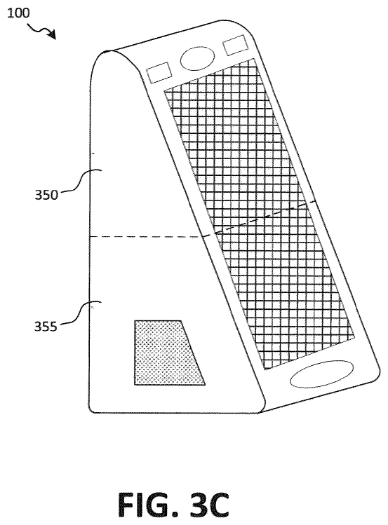

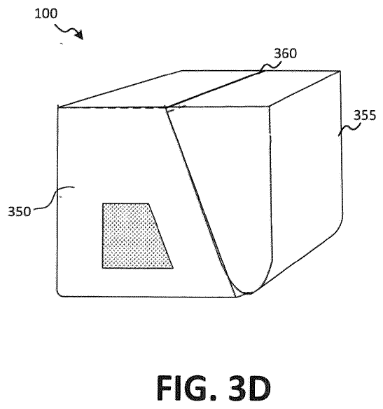

FIGS. 3A and 3B show an exemplary representation of a vertical configuration of the smart cat scratcher 100 implemented with functionality in accordance with embodiments of the present disclosure. It is noted that this vertical configuration example in FIG. 3A is provided for illustration purposes and not by way of limitation. In some embodiments, the vertical configuration of the smart cat scratcher 100 may be laid out or designed with a different configuration and layout of the different components. Thus, the specific configuration of the vertical configuration of the smart cat scratcher 100 provided in FIG. 3A should not be construed as limiting in any way.

As shown in FIG. 3A, the vertical configuration of the smart cat scratcher 100 may include a roughly triangular shape. In embodiments, the base on the vertical configuration may be configured with an area defined by l and w, where l defines the length and w defines the width of the vertical configuration. In embodiments, l may vary from 3 inches to 15 inches, and w may vary from 5 inches to 30 inches, accommodating different sizes to suit various spaces within a user's home. In embodiments, the height (h) of the vertical configuration may vary from 12 to 50 inches, providing ample vertical space for cats to stretch and scratch comfortably. To enhance stability and prevent slippage during use, the underside of the base may be fitted with a non-slip stabilizing material, ensuring that the smart cat scratcher remains securely in place while the cat engages in its natural scratching behavior. The vertical configuration may allow to be affixed permanently or temporarily to an object or wall for additional stabilization.

In the vertical configuration of the smart cat scratcher 100, the scratching surface 150 may be disposed at an angle from the rear wall of the smart cat scratcher 100, which may operate to conform to the cat's natural scratching posture and behavior. In embodiment, the angle of the scratching surface 150 may be between 25 and 75 degrees, and in some embodiments, may be adjustable, allowing for customization based on the cat's size, preference, and the available space within the user's home. This angled configuration may also operate to mimic the inclined surfaces that cats may naturally seek out for scratching in the wild, such as tree trunks or rocks. Alternatively, the vertical configuration of scratching surface 150 may be configured at an upright 90 degree angle, to tailor to cats' individual preferences.

In embodiments, the scratching surface 150 in the vertical configuration may be disposed within a scratching surface holder 153, which may be configured to securely retain the scratching surface while allowing for easy removal and replacement. The scratching surface holder 153 may enable the scratching surface 150 to be slidably removed, either from the bottom or from the top, facilitating convenient maintenance and the ability to replace the scratching surface when it becomes worn. This sliding mechanism may include a channel disposed along each lateral side configured to allow the edge of the scratching surface 150 to slide therethrough. This configuration may ensure that the scratching surface can be quickly and easily refreshed, maintaining its effectiveness and appeal to the cat.

In embodiments of the vertical configuration, the pressure-sensitive sensor 155 may be disposed under the scratching surface 150 to detect the presence and activity of the cat as it scratches the scratching surface 150. In embodiments, the pressure-sensitive sensor 155 may capture data on the intensity, duration, and pattern of the scratching, which may be used to trigger the dispensing of rewards and to monitor the cat's scratching behavior for training purposes.

In some embodiments, the scratching surface holder 153 may be configured to accommodate holding materials, such as Velcro or magnets, which may be used to secure the scratching surface 150 in place. This alternative holding method may provide additional flexibility in the design and maintenance of the smart cat scratcher, allowing for a variety of scratching surfaces to be used and easily interchanged based on the cat's preferences or the owner's desire to introduce different textures and materials for the cat to explore.

In the vertical configuration of the smart cat scratcher 100, the various components of the smart cat scratcher 100 may be arranged or disposed around the scratching surface 150 to enhance the cat's engagement and the overall functionality of the device. In embodiments, a camera 320 may be disposed above the scratching surface 150, providing a clear view of the cat as it approaches and interacts with the scratcher. This positioning of the camera 320 not only allows for the monitoring of the cat's behavior but may also facilitate capturing the surrounding environment, which may be useful for owners to observe their cat's interactions within the space.

Proximate to the camera 320, the engagement module 322 may be positioned to deliver interactive rewards that attract the cat's attention and encourage play. This module may include various stimuli such as lights, sounds, or moving objects that entice the cat to engage with the scratcher, providing both mental and physical stimulation. In this particular configuration of the smart cat scratcher 100, an interactive play toy 327 may be disposed along the length of the scratching surface 150, and may be configured to move around, offering the cat an additional form of entertainment and interaction. In embodiments, the toy 327 may be activated by the cat's touch or by the smart cat scratcher's system, providing a dynamic play experience that keeps the cat engaged and focused on the scratching surface.

A microphone 324 may be included and placed to capture the sounds of the cat's activity, which may be used for interactive communication between the cat and the owner or for monitoring purposes. The microphone 324 may also enhance the responsiveness of the smart cat scratcher by detecting the cat's vocalizations or the sound of scratching, triggering appropriate responses from the device.

In this example, the food-based reward dispenser 115 may be placed under the scratching surface 150 for easy access by the cat, allowing for immediate positive reinforcement following scratching behavior. Alternatively, the food-based reward dispenser 115 may be positioned at other locations, such as to the side or on the side wall, below the reward refill slot 315, to accommodate different configurations and user preferences. Rewards in the form of catnip or silver vine may be dispensed above the scratching surface 150 and sprinkled onto the scratching surface. In this example, the reward refill slot 315 may be located on the side of the smart cat scratcher, providing easy access for the owner to replenish the treats. This configuration ensures that maintaining the smart cat scratcher is a hassle-free process, encouraging consistent use and interaction by the cat.

With reference to FIG. 3B, during operation of the smart cat scratcher 100, the cat 326 may approach the smart cat scratcher 100. For example, the cat 326 may be enticed by the angled scratching surface 150, which is designed to mimic natural scratching posts found in the wild, and/or may act based on its training and/or desired to scratch. In any case, the cat 326 may extend its claws and engage in scratching behavior upon the scratching surface 150.

In response the scratching activity of the cat 326 upon the scratching surface 150, the pressure-sensitive sensor 155 may detect the pressure of the scratching activity upon the scratching surface 150 and the scratching activity may be detected. In embodiments, the pressure-sensitive sensor 155 beneath the scratching surface 150 may captures data on the intensity, duration, and pattern of the scratching activity. This data may be processed by the scratcher controller 110 (e.g., in accordance with embodiments described herein), which may determine whether the scratching activity meets the criteria for dispensing a reward.

If the criteria are met, the food-based reward dispenser 115 may be activated, dispensing a treat directly to the cat. The treat may be released in a location that is easily accessible to the cat, providing immediate positive reinforcement for the scratching behavior. This immediate reward helps to reinforce the cat's use of the smart cat scratcher instead of other household items, such as furniture or carpets.

In addition, or in the alternative, to food-based rewards, the engagement module 322 may provide interactive rewards that encourage the cat to use the smart cat scratcher. The engagement module 322 may include various stimuli such as lights, sounds, or moving objects. For example, a light show or laser pointer may be activated to create patterns that the cat can chase, stimulating its hunting instincts and drawing it back to the smart cat scratcher.

In embodiments, the camera 320 and microphone 324 may work in tandem to enhance the interactive experience. The camera 320 may allow the owner to monitor the cat's behavior and even view live scratching sessions through the connected app. The microphone 324 may capture the cat's vocalizations, enabling two-way communication between the cat and the owner, which may be comforting for the cat and reassuring for the owner.

The interactive play toy 327, which may be a moving flirt-pole or dangling toy, adds an additional layer of engagement. When the cat touches or interacts with the toy, or in response to the scratching activity upon the scratching surface 150, the toy 327 may move or make sounds, providing a playful experience that keeps the cat entertained and focused on the smart cat scratcher 100.

FIGS. 3C and 3D show an example packaging configuration of the vertical configuration of the smart cat scratcher 100 implemented with functionality in accordance with embodiments of the present disclosure. As shown in FIG. 3C, the smart cat scratcher 100 may be provided in a two-part construction, including an upper portion 350 and a lower portion 355. In embodiments, the upper portion 350 and the lower portion 355 may be distinct parts of the smart cat scratcher 100. In embodiments, the upper portion 350 and the lower portion 355 may be configured to be securely assembled for use (e.g., using Velcro and/or other fastening mechanisms). The modular configuration provided by the upper portion 350 and a lower portion 355 simplifies the assembly process for the user and streamlines the packaging and shipping, as the separate portions may complement each other (e.g., the shape of the upper portion 350 may complement the shape of the lower portion 355) and may be compactly packed.

For example, for packaging purposes, the upper portion 350 and the lower portion 355 may be detached from each other, reducing the overall size and making the packaging more efficient. For example, as shown in FIG. 3D, the upper portion 355 may be positioned to abut the lower portion 350, which may result in a combined shape that is near rectangular, as the shape of the two portions complement each other rectangularly. This feature may be particularly advantageous for transportation and storage, as it minimizes the space requirements and may lead to cost savings in logistics and storage. In embodiments, a hinge portion 360 may be configured to allow the upper portion 350 and the lower portion 355 to remain connected while still being able to fold into a near rectangular shape. The hinge portion 360 may facilitate a folding action that brings the upper portion 350 and the lower portion 355 together into a flat, near rectangular shape, which can easily fit into a standard rectangular shipping box.

In embodiments, the scratching surface 150, may be configured for easy packaging. For example, the scratching surface 150 may be provided as a single piece that folds along with the two portions or may be provided as two separate pieces that correspond to the upper and lower portions of the scratcher. This configuration of the scratching surface 150 may ensure that the scratching surface 150 aligns with the compact packaging configuration of the smart cat scratcher 100.

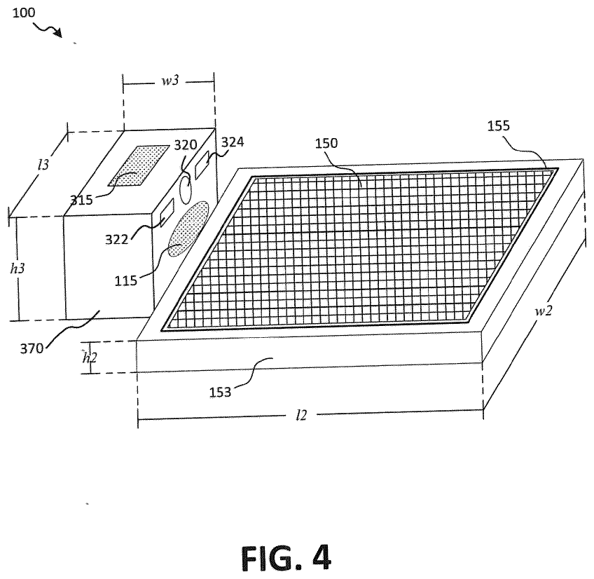

FIG. 4 shows an exemplary representation of a horizontal configuration of the smart cat scratcher 100 implemented with functionality in accordance with embodiments of the present disclosure. It is noted that this horizontal configuration example in FIG. 4 is provided for illustration purposes and not by way of limitation. In some embodiments, the horizontal configuration of the smart cat scratcher 100 may be laid out or designed with a different configuration and layout of the different components, or may be combined with the vertical configuration to form an L-shape. Thus, the specific configuration of the horizontal configuration of the smart cat scratcher 100 provided in FIG. 4 should not be construed as limiting in any way.

As shown in FIG. 4, in the horizontal configuration of the smart cat scratcher 100, the scratching surface 150 may lay horizontally. In embodiments, the horizontal configuration of the smart cat scratcher 100 may be configured to cater to cats that prefer scratching in a horizontal plane, which may be more natural for some feline behaviors such as stretching out fully while scratching. The horizontal configuration may be particularly appealing to cats that are less inclined to use vertical scratching posts, providing an alternative that still fulfills their instinctual scratching urges. The horizontal configuration may also serve as a lounging spot for the cat, combining the utility of a scratcher with the comfort of a resting area.

In embodiments, the main portion of the horizontal configuration may include the scratching surface 150, positioned horizontally on the scratching surface holder 153, and under which pressure-sensitive sensor 155 is disposed. The size of the main portion where the scratching surface 150 is disposed (e.g., which may be the size of the scratching surface holder 153 in some embodiments) may include a volume defined by a height h2, a length l2, and a width w2. In embodiments, the length l2 may vary from 12 inches to 50 inches, the width w2 may vary from 2 inches to 15 inches, and the height h2 may vary from 0.5 to 4 inches, accommodating different sizes to suit various spaces within a user's home. To enhance stability and prevent slippage during use, the underside of the base may be fitted with a non-slip stabilizing material, ensuring that the smart cat scratcher remains securely in place while the cat engages in its natural scratching behavior.

In embodiments, the horizontal configuration includes similar components to the vertical configuration, such as the food-based reward dispenser 115, a camera 320, a microphone 324, an engagement module 322, and a reward refill slot 315, but with a notable difference in the arrangement of the processing components and sensors. In the horizontal configuration, the processing components, and sensors, except for the pressure-sensitive sensor 155, are included within a housing unit 370. The housing unit 370 may be disposed next to the scratching surface 150, consolidating the smart functionalities of the device into a compact and discrete area that does not interfere with the cat's scratching space. In embodiments, the size of the housing unit 370 may include a volume defined by a height h3, a length l3, and a width w3. In embodiments, the length l3 may vary from 2 inches to 15 inches, the width w3 may vary from 2 inches to 8 inches, and the height h3 may vary from 4 inches to 16 inches.

In embodiments, the horizontal configuration provides the advantages of ease of access for cats of all ages and physical abilities, as there is no height barrier to climb or jump over. The horizontal configuration may also allow for a larger scratching area, which may be beneficial for multi-cat households where several cats may want to use the scratcher simultaneously.

In embodiments, the horizontal configuration of the smart cat scratcher 100 may be configured to be packaged efficiently. For example, in some embodiments, the housing unit 370, which contains the processing components and sensors, may be detachable from the scratching surface assembly (e.g., which may include the scratching surface 150, the scratching surface holder 153, and the pressure-sensitive sensor 155), allowing for a more streamlined packaging process. The separation may simplify the packaging and may reduce the risk of damage during transit by minimizing the movement of internal components. The compact and flat profile of the disassembled unit fits neatly into a standard shipping box, optimizing space and reducing shipping costs. This feature is particularly beneficial for e-commerce distribution, where packaging efficiency can have a direct impact on logistics and customer satisfaction. The ease of reassembly upon delivery ensures that the end-user may quickly set up the smart cat scratcher 100 for immediate use by their feline companions.

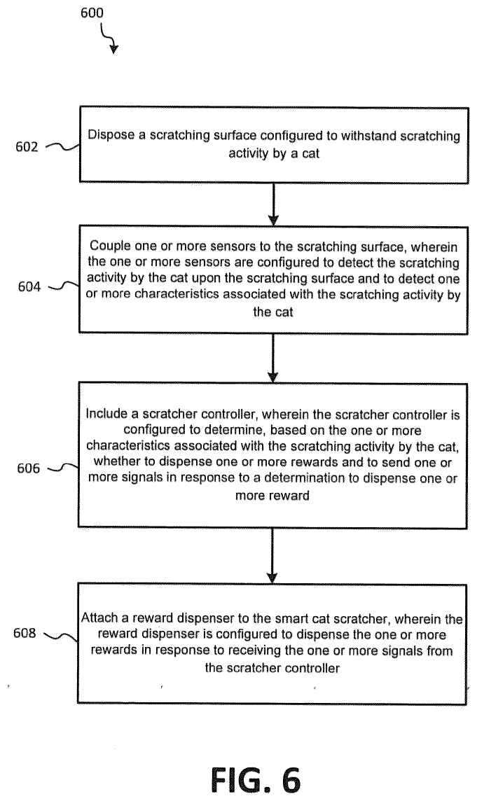

FIG. 6 shows an exemplary flow diagram of operations for manufacturing a smart cat scratcher configured with functionality for automatically dispensing rewards in response to scratching activity in accordance with aspects of the present disclosure. For example, the steps illustrated in the example blocks shown in FIG. 6 may be performed to manufacture smart cat scratcher 100 of FIGS. 1-5F, according to embodiments herein.

At block 602, a scratching surface (e.g., scratching surface 150 of FIG. 1) configured to withstand scratching activity by a cat is disposed upon the smart cat scratcher. In embodiments, the scratching surface may be disposed based on the configuration of the smart cat scratcher. For example, in a vertical configuration, the scratching surface may be disposed at an angle based on the vertical configuration (e.g., as shown in FIG. 3A). In a horizontal configuration, the scratching surface may be disposed horizontally based on the horizontal configuration (e.g., as shown in FIG. 4).

At block 604, one or more sensors (e.g., one or more sensors 120 of FIG. 1) are coupled to the scratching surface. In embodiments, the one or more sensors may be configured to detect the scratching activity by the cat upon the scratching surface and to detect one or more characteristics associated with the scratching activity by the cat.

At block 606, a scratcher controller (e.g., scratcher controller 110 of FIG. 1) is included in the smart cat scratcher. In embodiments, the scratcher controller may be configured to determine, based on the one or more characteristics associated with the scratching activity by the cat, whether to dispense one or more rewards and to send one or more signals in response to a determination to dispense one or more reward.

At block 608, a reward dispenser (e.g., food-based reward dispenser 115 and/or engagement module 122) is attached to the smart cat scratcher. In embodiments, the reward dispenser may be configured to dispense the one or more rewards in response to receiving the one or more signals from the scratcher controller.

In embodiments, manufacturing the smart cat scratcher may include configuring the scratcher controller with a reward protocol that includes a maintenance protocol for maintaining the cat's established scratching behavior and a training protocol for guiding the cat's scratching activities towards the scratching surface. In embodiments, the training protocol may include a plurality of training levels. In embodiments, the scratcher controller may be configured to graduate the cat from one training level to another based on the cat's progress in scratching behavior.

In embodiments, the smart cat scratcher may be configured to be disassembled into an upper portion and a lower portion for packaging. In embodiments, the upper portion and the lower portion may complement each other rectangularly. In some embodiments, a hinge portion may be included attaching the upper portion to the lower portion and allowing the upper portion and the lower portion to remain attached while enabling the smart cat scratcher to be folded for packaging.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A smart cat scratcher, comprising:
a scratching surface;
one or more sensors configured to:
detect a scratching activity by a cat upon the scratching surface; and
detect one or more characteristics associated with the scratching activity by the cat;
a scratcher controller configured to:
determine, based on the one or more characteristics associated with the scratching activity by the cat, whether to dispense one or more rewards; and
send one or more signals to a reward dispenser in response to a determination to dispense one or more rewards;
the reward dispenser configured to dispense the one or more rewards in response to receiving the one or more signals from the scratcher controller.

2. The smart cat scratcher of claim 1, wherein the one or more sensors include a pressure-sensitive sensor configured to detect a pressure associated with the scratching activity by the cat upon the scratching surface, wherein detecting the scratching activity is based on the pressure associated with the scratching activity by the cat upon the scratching surface.

3. The smart cat scratcher of claim 1, wherein the one or more characteristics associated with the scratching activity includes one or more of an intensity of the scratching activity, a duration of the scratching activity, and a pattern of the scratching activity.

4. The smart cat scratcher of claim 3, wherein the scratcher controller is further configured to determine a quality level of the scratching activity based, at least in part, on the one or more characteristics associated with the scratching activity.

5. The smart cat scratcher of claim 4, wherein the configuration of the scratcher controller to determine whether to dispense the one or more rewards is based on the quality level of the scratching activity exceeding a predetermined quality threshold, wherein the scratcher controller is configured to determine to dispense the one or more rewards when the quality level of the scratching activity exceeds the predetermined quality threshold.

6. The smart cat scratcher of claim 1, wherein the configuration of the scratcher controller to determine whether to dispense the one or more rewards includes configuration to determine whether to dispense the one or more rewards based on a reward protocol including:
a maintenance protocol configured to generate and manage a partial reinforcement schedule in which rewards are dispensed intermittently based on the detected scratching activity to maintain the cat's established scratching behavior; and
a training protocol configured to train the cat's scratching behavior to guide the cat's scratching activities towards the scratching surface of the smart cat scratcher and away from other objects.

7. The smart cat scratcher of claim 6, wherein the training protocol includes a plurality of training levels, and the scratcher controller is configured to graduate the cat from one training level to another based on the cat's progress.

8. The smart cat scratcher of claim 7, wherein the plurality of training levels includes a beginner level, an advanced level, and an expert level, each level having corresponding reward schedules and criteria for graduation to a subsequent level.

9. The smart cat scratcher of claim 8, wherein the scratcher controller is configured to dispense rewards more frequently at the beginner level to establish an initial association between scratching the designated surface and receiving a reward, and to dispense rewards less frequently at the expert level to maintain the established scratching behavior with partial reinforcement.

10. The smart cat scratcher of claim 6, wherein the scratcher controller is configured to analyze the one or more characteristics associated with the scratching activity to assess the cat's engagement with the scratching surface and to adjust one or more of the training protocol and the maintenance protocol dynamically.

11. The smart cat scratcher of claim 10, wherein the scratcher controller is configured to adjust a reward schedule of the reward protocol based on the cat's scratching activity, increasing or decreasing the frequency of rewards to optimize reward protocol's effectiveness.

12. The smart cat scratcher of claim 1, wherein the one or more rewards include one or more of a food-based reward and an interactive reward.

13. The smart cat scratcher of claim 1, wherein the one or more signals from the scratcher controller to the reward dispenser include one or more of:
a signal to actuate a door to allow food-based rewards to be dispensed from a container of the reward dispenser; and
a signal to activate an interactive reward that includes one or more of a motion, light, video, and audio activity.

14. The smart cat scratcher of claim 1, wherein the one or more sensors include one or more cameras configured to capture image data related to an area surrounding the smart cat scratcher, and wherein the scratcher controller is configured to one or more of:
identify, based on the image data captured by the one or more cameras, inappropriate scratching behavior by the cat, and adjust one or more of a reward schedule, reward criteria, reward intensity, and reward type based on an identification of inappropriate scratching behavior by the cat;
identify, based on the image data captured by the one or more cameras, appropriate scratching behavior on the scratching surface, and determine a quality of the appropriate scratching behavior to determine whether to dispense the one or more rewards; and
determine an identity of the cat based on the image data captured by the one or more cameras.

15. A method of manufacturing a smart cat scratcher, comprising:
disposing a scratching surface configured to withstand scratching activity by a cat;
coupling one or more sensors to the scratching surface, wherein the one or more sensors are configured to detect the scratching activity by the cat upon the scratching surface and to detect one or more characteristics associated with the scratching activity by the cat;
including a scratcher controller, wherein the scratcher controller is configured to determine, based on the one or more characteristics associated with the scratching activity by the cat, whether to dispense one or more rewards and to send one or more signals in response to a determination to dispense one or more reward; and
attaching a reward dispenser to the smart cat scratcher, wherein the reward dispenser is configured to dispense the one or more rewards in response to receiving the one or more signals from the scratcher controller.

16. The method of claim 15, further comprising:
configuring the scratcher controller with a reward protocol that includes a maintenance protocol for maintaining the cat's established scratching behavior and a training protocol for guiding the cat's scratching activities towards the scratching surface.

17. The method of claim 16, wherein the training protocol includes a plurality of training levels, and wherein the scratcher controller is configured to graduate the cat from one training level to another based on the cat's progress in scratching behavior.

18. The method of claim 15, wherein the smart cat scratcher is configured to be disassembled into an upper portion and a lower portion for packaging, wherein the upper portion and the lower portion complement each other rectangularly.

19. A system for implementing a reward protocol for a smart cat scratcher, comprising:
at least one processor; and
a memory operably coupled to the at least one processor and storing processor-readable code that, when executed by the at least one processor, is configured to perform operations including:
determining one or more characteristics associated with a scratching activity upon a scratching surface;
determining whether to dispense one or more rewards based on the one or more characteristics associated with the scratching activity in accordance with a reward protocol, wherein the reward protocol includes a maintenance protocol for sustaining established scratching behavior and a training protocol for promoting and reinforcing desired scratching behavior, wherein the maintenance protocol includes intermittent dispensing of rewards to maintain the established scratching behavior, wherein the training protocol includes a progression of training levels with corresponding reward schedules to guide the cat's scratching behavior towards the scratching surface, and wherein the training protocol defines a transition of the cat through the training levels based on the cat's interaction with the scratching surface.

20. The system of claim 19, wherein the training levels include a beginner level, an advanced level, and an expert level, each level having corresponding reward schedules and criteria for graduation to a subsequent level, wherein rewards are dispensed more frequently at the beginner level to establish an initial association between scratching the designated surface and receiving a reward, and rewards are dispensed less frequently at the expert level to maintain the established scratching behavior with partial reinforcement.
